(19) United States
(12) Patent Application Publication
(10) Pub. No.: US 2026/0121698 A1
(43) Pub. Date: Apr. 30, 2026

(54) OPERATING STATE TRANSITIONS IN OVERLAPPING BASIC SERVICE SETS

(71) Applicant: QUALCOMM Incorporated, San Diego, CA (US)

(72) Inventors: Sherief HELWA, San Diego, CA (US); George CHERIAN, San Diego, CA (US); Gaurang NAIK, San Diego, CA (US); Abhishek Pramod PATIL, San Diego, CA (US); Alfred ASTERJADHI, San Diego, CA (US); Sanket Sanjay KALAMKAR, San Diego, CA (US); Giovanni CHISCI, San Diego, CA (US); Sai Yiu Duncan HO, San Diego, CA (US)

(21) Appl. No.: 18/927,664

(22) Filed: Oct. 25, 2024

(51) Int. Cl. H04B 7/0417; H04B 7/022; H04B 7/0452; H04B 7/06; H04W 76/27

(52) U.S. Cl. CPC H04B 7/0417; H04B 7/022; H04B 7/0452; H04B 7/0626; H04W 76/27

(57) ABSTRACT

This disclosure provides methods, components, devices and systems for operating state transitions in overlapping basic service sets. Some aspects more specifically relate to the transmission of one or more initial control frames (ICFs) and initial control responses (ICRs) during the channel sounding phase and the transmission phase of a CBF operation to prepare one or more STAs to receive data. During each channel sounding sequence of the channel sounding phase of the CBF operation, an AP may transmit one or more ICFs to one or more STAs requesting the one or more STAs to transition from a first operating state to a second operating state to prepare to receive one or more frames. During the transmission phase of the CBF operation, an ICF/ICR exchange may take place between each AP and one or more associated STAs to prepare the one or more associated STAs for reception of a downlink PPDU.

### TECHNICAL FIELD

This disclosure relates generally to wireless communication and, more specifically, to operating state transitions in overlapping basic service sets (OBSSs). Various aspects relate generally to coordinated beamforming (CBF) operations in an OBSS. Some aspects more specifically relate to the transmission of one or more initial control frames (ICFs) and initial control responses (ICRs) during the channel sounding phase and the transmission phase of a CBF operation to prepare one or more STAs to receive data.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect may include a method for wireless communications by a first access point (AP) is described. The method may include communicating, with a second AP, a coordinated beamforming trigger frame associated with triggering a set of multiple stations (STAs) to transition from a first operating state to a second operating state for reception of coordinated beamformed messaging by the first AP and the second AP, transmitting, to one or more STAs of the set of multiple STAs, an initial control frame (ICF) to trigger the one or more STAs to transition from the first operating state to the second operating state, receiving, from the one or more STAs, an initial control response (ICR) based on the ICF, and transmitting, to the one or more STAs, a data message based on the ICR and the coordinated beamforming trigger frame.

A first AP for wireless communications is described. The first AP may include a processing system that includes processor circuitry and memory circuitry that stores code. The processing system may be configured to cause the first AP to communicate, with a second AP, a coordinated beamforming trigger frame associated with triggering a set of multiple STAs to transition from a first operating state to a second operating state for reception of coordinated beamformed messaging by the first AP and the second AP, transmit, to one or more STAs of the set of multiple STAs, an ICF to trigger the one or more STAs to transition from the first operating state to the second operating state, receive, from the one or more STAs, an ICR based on the ICF, and transmit, to the one or more STAs, a data message based on the ICR and the coordinated beamforming trigger frame.

Another first AP for wireless communications is described. The first AP may include means for communicating, with a second AP, a coordinated beamforming trigger frame associated with triggering a set of multiple STAs to transition from a first operating state to a second operating state for reception of coordinated beamformed messaging by the first AP and the second AP, means for transmitting, to one or more STAs of the set of multiple STAs, an ICF to trigger the one or more STAs to transition from the first operating state to the second operating state, means for receiving, from the one or more STAs, an ICR based on the ICF, and means for transmitting, to the one or more STAs, a data message based on the ICR and the coordinated beamforming trigger frame.

A non-transitory computer-readable medium storing code for wireless communications is described. The code may include instructions executable by one or more processors to communicate, with a second AP, a coordinated beamforming trigger frame associated with triggering a set of multiple STAs to transition from a first operating state to a second operating state for reception of coordinated beamformed messaging by the first AP and the second AP, transmit, to one or more STAs of the set of multiple STAs, an ICF to trigger the one or more STAs to transition from the first operating state to the second operating state, receive, from the one or more STAs, an ICR based on the ICF, and transmit, to the one or more STAs, a data message based on the ICR and the coordinated beamforming trigger frame.

In some examples of the method, first APs, and non-transitory computer-readable medium described herein, communicating the coordinated beamforming trigger frame may include operations, features, means, or instructions for transmitting, to the second AP, the coordinated beamforming trigger frame, the method further including and receiving, from the second AP, a coordinated beamforming response frame based on the coordinated beamforming trigger frame.

In some examples of the method, first APs, and non-transitory computer-readable medium described herein, communicating the coordinated beamforming trigger frame may include operations, features, means, or instructions for receiving, from the second AP, the coordinated beamforming trigger frame, the method further including, and transmitting, to the second AP, a coordinated beamforming response frame based on the coordinated beamforming trigger frame.

In some examples of the method, first APs, and non-transitory computer-readable medium described herein, the ICF may be transmitted before a first time occasion associated with transmission of a second ICF by the second AP and the first AP skips transmission during the first time occasion and during a second time occasion associated with transmission of a second ICR by a STA associated with the second AP.

Some examples of the method, first APs, and non-transitory computer-readable medium described herein may further include operations, features, means, or instructions for transmitting, to the one or more STAs of the set of multiple STAs, an indication to switch from a default timeout period duration to an extended timeout period duration based on the ICF, where the indication indicates that the one or more STAs of the set of multiple STAs may be permitted to switch back to the first operating state after the extended timeout period duration if no frames may be received during the extended timeout period duration.

In some examples of the method, first APs, and non-transitory computer-readable medium described herein, transmitting the ICF may include operations, features, means, or instructions for transmitting the ICF concurrent with transmission of a second ICF by the second AP, where the ICF and the second ICF may be identical and may be transmitted synchronously, and where the ICR may be received in a first set of resource units different from a second set of resource units used to transmit a second ICR by a STA associated with the second AP.

Some examples of the method, first APs, and non-transitory computer-readable medium described herein may further include operations, features, means, or instructions for transmitting, to the one or more STAs of the set of multiple STAs, an earlier indication to respond to a frame including a unified transmitter address value, where the ICF may be transmitted with the unified transmitter address value and where the ICR may be received based on the indication and the unified transmitter address value.

In some examples of the method, first APs, and non-transitory computer-readable medium described herein, a basic service set color field may be excluded from a physical header or set to.

In some examples of the method, first APs, and non-transitory computer-readable medium described herein, a basic service set color may be indicated in a user information field within the ICF based on the first AP and the second AP sharing a same association identifier (AID).

Some examples of the method, first APs, and non-transitory computer-readable medium described herein may further include operations, features, means, or instructions for transmit, to the second AP, first STA information and receive, from the second AP, second STA information, where the ICF may be transmitted concurrently with transmission of a second ICF by the second AP based on the first STA information and the second STA information, where the ICF and the second ICF may be identical and may be transmitted synchronously.

In some examples of the method, first APs, and non-transitory computer-readable medium described herein, transmitting the ICF may include operations, features, means, or instructions for transmitting, using a unified transmission address value, the ICF to a first subset of one or more STAs of the set of multiple STAs, where the first subset of one or more STAs may be associated with the first AP, and where the ICR may be received in a first set of resource units different from a second set of resource units used to transmit a second ICR by a STA associated with the second AP and transmitting, using the unified transmission address value, the ICF to a second subset of one or more STAs of the set of multiple STAs, where the second subset of one or more STAs may be associated with the second AP.

In some examples of the method, first APs, and non-transitory computer-readable medium described herein, a coordinated beamforming response frame and the ICF frame may be transmitted in a same frame and the ICR may be received in a first set of resource units different from a second set of resource units used to transmit a second ICR by a STA associated with the second AP.

In some examples of the method, first APs, and non-transitory computer-readable medium described herein, transmitting the ICF may include operations, features, means, or instructions for transmitting, via a first set of resource units, the ICF concurrent with transmission of a second ICF by the second AP via a second set of resource units and receiving, via a third set of resource units, the ICR concurrent with transmission of a second ICR by a STA associated with the second AP via a fourth set of resource units.

Some examples of the method, first APs, and non-transitory computer-readable medium described herein may further include operations, features, means, or instructions for transmitting, to the second AP, an acknowledgment message, a synchronization message, or both, where the ICF and a second ICF may be transmitted concurrently or staggered in time by the first AP and the second AP to the one or more STAs based on the acknowledgment message, the synchronization message, or both.

Some examples of the method, first APs, and non-transitory computer-readable medium described herein may further include operations, features, means, or instructions for transmitting, to the second AP, a synchronization message, where a first data message may be transmitted to the one or more STAs concurrently with a second data message by the second AP based on the synchronization message.

Some examples of the method, first APs, and non-transitory computer-readable medium described herein may further include operations, features, means, or instructions for receiving, from the second AP, an acknowledgment message, a synchronization message, or both, where the ICF and a second ICF may be transmitted concurrently or staggered in time by the first AP and the second AP to the one or more STAs based on the acknowledgment message, the synchronization message, or both.

Some examples of the method, first APs, and non-transitory computer-readable medium described herein may further include operations, features, means, or instructions for receiving, from the second AP, a synchronization message, where a second data message may be transmitted to the one or more STAs concurrently with a first data message by the first AP based on the synchronization message.

A method for wireless communications by a first AP is described. The method may include transmitting, to one or more STAs of a set of multiple STAs, an ICF to trigger the one or more STAs to transition from a first operating state to a second operating state, where transmission of the ICF is associated with a set of multiple channel sounding procedures, monitoring, during a first channel sounding procedure of the set of multiple channel sounding procedures, for an ICR from the one or more STAs based on the ICF, wherein exchange of the ICF and the ICR occurs prior to each channel sounding procedure of the plurality of channel sounding procedures, transmitting, to a set of one or more first STAs associated with the first AP, one or more frames during the first channel sounding procedure, triggering the second AP to transmit, to the set of one or more first STAs associated with the first AP, one or more frames during the first channel sounding procedure, and receiving, from the set of one or more first STAs associated with the first AP, a channel state information (CSI) frame.

A first AP for wireless communications is described. The first AP may include a processing system that includes processor circuitry and memory circuitry that stores code. The processing system may be configured to cause the first AP to transmit, to one or more STAs of a set of multiple STAs, an ICF to trigger the one or more STAs to transition from a first operating state to a second operating state, where transmission of the ICF is associated with a set of multiple channel sounding procedures, monitor, during a first channel sounding procedure of the set of multiple channel sounding procedures, for an ICR from the one or more STAs based on the ICF, wherein exchange of the ICF and the ICR occurs prior to each channel sounding procedure of the plurality of channel sounding procedures, transmit, to a set of one or more first STAs associated with the first AP, one or more frames during the first channel sounding procedure, trigger the second AP to transmit, to the set of one or more first STAs associated with the first AP, one or more frames during the first channel sounding procedure, and receive, from the set of one or more first STAs associated with the first AP, a CSI frame.

Another first AP for wireless communications is described. The first AP may include means for transmitting, to one or more STAs of a set of multiple STAs, an ICF to trigger the one or more STAs to transition from a first operating state to a second operating state, where transmission of the ICF is associated with a set of multiple channel sounding procedures, means for monitoring, during a first channel sounding procedure of the set of multiple channel sounding procedures, for an ICR from the one or more STAs based on the ICF, wherein exchange of the ICF and the ICR occurs prior to each channel sounding procedure of the plurality of channel sounding procedures, means for transmitting, to a set of one or more first STAs associated with the first AP, one or more frames during the first channel sounding procedure, means for triggering the second AP to transmit, to the set of one or more first STAs associated with the first AP, one or more frames during the first channel sounding procedure, and means for receiving, from the set of one or more first STAs associated with the first AP, a CSI frame.

A non-transitory computer-readable medium storing code for wireless communications is described. The code may include instructions executable by one or more processors to transmit, to one or more STAs of a set of multiple STAs, an ICF to trigger the one or more STAs to transition from a first operating state to a second operating state, where transmission of the ICF is associated with a set of multiple channel sounding procedures, monitor, during a first channel sounding procedure of the set of multiple channel sounding procedures, for an ICR from the one or more STAs based on the ICF, wherein exchange of the ICF and the ICR occurs prior to each channel sounding procedure of the plurality of channel sounding procedures, transmit, to a set of one or more first STAs associated with the first AP, one or more frames during the first channel sounding procedure, trigger the second AP to transmit, to the set of one or more first STAs associated with the first AP, one or more frames during the first channel sounding procedure, and receive, from the set of one or more first STAs associated with the first AP, a CSI frame.

Some examples of the method, first APs, and non-transitory computer-readable medium described herein may further include operations, features, means, or instructions for transmitting, during the first channel sounding procedure, a first null data packet frame concurrent with transmission of a second null data packet frame by the second AP.

In some examples of the method, first APs, and non-transitory computer-readable medium described herein, the first operating state may be a listening state and the second operating state may be an active state and reception of the ICR from the one or more STAs indicates a transition from the listening state to the active state.

Some examples of the method, first APs, and non-transitory computer-readable medium described herein may further include operations, features, means, or instructions for receiving, from a first STA of the one or more STAs, a first ICR that indicates unavailability information associated with the first STA, where a first null data packet frame and a second null data packet frame may be transmitted in accordance with the unavailability information.

In some examples of the method, first APs, and non-transitory computer-readable medium described herein, the first operating state may be a low capability state and the second operating state may be a high capability state and reception of the ICR from the one or more STAs indicates transition from the low capability state to the high capability state.

In some examples of the method, first APs, and non-transitory computer-readable medium described herein, transmitting the ICF may include operations, features, means, or instructions for transmitting a request for the one or more STAs to transmit the ICR in a trigger-based physical layer protocol and transmitting, to the second AP, a request for the second AP to transition from a first operating state to a second operating state.

A method for wireless communications by a first AP is described. The method may include transmitting, to one or more STAs of a set of multiple STAs, an ICF to trigger the one or more STAs to transition from a first operating state to a second operating state, where transmission of the ICF is associated with a set of multiple channel sounding procedures, monitoring, during a first channel sounding procedure of the set of multiple channel sounding procedures, for an ICR from the one or more STAs based on the ICF, wherein exchange of the ICF and the ICR occurs between each channel sounding procedure of the plurality of channel sounding procedures, transmitting, to a set of first STAs associated with the first AP and based on the ICR, a first null data packet announcement frame during the first channel sounding procedure, transmitting, to the set of first STAs, a first null data packet frame based on the first null data packet announcement frame, triggering the second AP to transmit a second null data packet frame during the first channel sounding procedure, transmitting, to the set of first STAs associated with the first AP and based on the first null data packet frame, a beamforming report poll frame during the first channel sounding procedure, and receiving, based on the beamforming report poll frame, a channel state information frame from the set of first STAs associated with the first AP.

A first AP for wireless communications is described. The first AP may include a processing system that includes processor circuitry and memory circuitry that stores code. The processing system may be configured to cause the first AP to transmit, to one or more STAs of a set of multiple STAs, an ICF to trigger the one or more STAs to transition from a first operating state to a second operating state, where transmission of the ICF is associated with a set of multiple channel sounding procedures, monitor, during a first channel sounding procedure of the set of multiple channel sounding procedures, for an ICR from the one or more STAs based on the ICF, wherein exchange of the ICF and the ICR occurs between each channel sounding procedure of the plurality of channel sounding procedures, transmit, to a set of first STAs associated with the first AP and based on the ICR, a first null data packet announcement frame during the first channel sounding procedure, transmit, to the set of first STAs, a first null data packet frame based on the first null data packet announcement frame, trigger the second AP to transmit a second null data packet frame during the first channel sounding procedure, transmit, to the set of first STAs associated with the first AP and based on the first null data packet frame, a beamforming report poll frame during the first channel sounding procedure, and receive, based on the beamforming report poll frame, a channel state information frame from the set of first STAs associated with the first AP.

Another first AP for wireless communications is described. The first AP may include means for transmitting, to one or more STAs of a set of multiple STAs, an ICF to trigger the one or more STAs to transition from a first operating state to a second operating state, where transmission of the ICF is associated with a set of multiple channel sounding procedures, means for monitoring, during a first channel sounding procedure of the set of multiple channel sounding procedures, for an ICR from the one or more STAs based on the ICF, wherein exchange of the ICF and the ICR occurs between each channel sounding procedure of the plurality of channel sounding procedures, means for transmitting, to a set of first STAs associated with the first AP and based on the ICR, a first null data packet announcement frame during the first channel sounding procedure, means for transmitting, to the set of first STAs, a first null data packet frame based on the first null data packet announcement frame, means for triggering the second AP to transmit a second null data packet frame during the first channel sounding procedure, means for transmitting, to the set of first STAs associated with the first AP and based on the first null data packet frame, a beamforming report poll frame during the first channel sounding procedure, and means for receiving, based on the beamforming report poll frame, a channel state information frame from the set of first STAs associated with the first AP.

A non-transitory computer-readable medium storing code for wireless communications is described. The code may include instructions executable by one or more processors to transmit, to one or more STAs of a set of multiple STAs, an ICF to trigger the one or more STAs to transition from a first operating state to a second operating state, where transmission of the ICF is associated with a set of multiple channel sounding procedures, monitor, during a first channel sounding procedure of the set of multiple channel sounding procedures, for an ICR from the one or more STAs based on the ICF, wherein exchange of the ICF and the ICR occurs between each channel sounding procedure of the plurality of channel sounding procedures, transmit, to a set of first STAs associated with the first AP and based on the ICR, a first null data packet announcement frame during the first channel sounding procedure, transmit, to the set of first STAs, a first null data packet frame based on the first null data packet announcement frame, trigger the second AP to transmit a second null data packet frame during the first channel sounding procedure, transmit, to the set of first STAs associated with the first AP and based on the first null data packet frame, a beamforming report poll frame during the first channel sounding procedure, and receive, based on the beamforming report poll frame, a channel state information frame from the set of first STAs associated with the first AP.

In some examples of the method, first APs, and non-transitory computer-readable medium described herein, the first null data packet frame may be transmitted concurrent with transmission of a second null data packet frame by the second AP.

In some examples of the method, first APs, and non-transitory computer-readable medium described herein, the first operating state may be a listening state and the second operating state may be an active state and reception of the ICR from the one or more STAs indicates a transition from the listening state to the active state.

Some examples of the method, first APs, and non-transitory computer-readable medium described herein may further include operations, features, means, or instructions for receiving, from a first STA of the one or more STAs, a first ICR that indicates unavailability information associated with the first STA, where a first null data packet frame and a second null data packet frame may be transmitted in accordance with the unavailability information.

In some examples of the method, first APs, and non-transitory computer-readable medium described herein, the first operating state may be a low capability state and the second operating state may be a high capability state and reception of the ICR from the one or more STAs indicates transition from the low capability state to the high capability state.

In some examples of the method, first APs, and non-transitory computer-readable medium described herein, transmitting the ICF may include operations, features, means, or instructions for transmitting a request for the one or more STAs to transmit the ICR in a trigger-based physical layer protocol and transmitting, to the second AP, a request for the second AP to transition from a first operating state to a second operating state.

Details of one or more implementations of the subject matter described in this disclosure are set forth in the accompanying drawings and the description below. Other features, aspects, and benefits will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIGS. 2 through 14 show examples of signaling diagrams that supports operating state transitions in overlapping basic service sets.

FIG. 15 shows a block diagram of an example wireless communication device that supports operating state transitions in overlapping basic service sets.

FIGS. 16 through 18 show flowcharts illustrating example processes performable by or at a first access point (AP) that supports operating state transitions in overlapping basic service sets.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks may support a coordinated beamforming (CBF) operation in which two or more access points (APs) simultaneously use the medium in two or more basic service sets (BSSs) to maximize the system throughput (such as in an overlapping BSS (OBSS)). For example, each AP in the two or more BSSs may null an associated signal at one or more stations (STAs) associated with the other APs. A CBF operation may include a channel sounding phase to make channel state information (CSI) available at each AP and a transmission phase, where the two or more APs agree on which client STAs will be served and synchronize transmissions. However, in some implementations, the client STAs in an OBSS may not be immediately ready to receive data. For example, an eMLSR link between a STA and an AP may not be activated. In some examples, a STA may be unavailable to receive data due to CoEx operations. In some examples, a dynamic power-saving (DPS) STA may be in a low capability state.

Various aspects relate generally to CBF operations in an OBSS. Some aspects more specifically relate to the transmission of one or more initial control frames (ICFs) and initial control responses (ICRs) during the channel sounding phase and the transmission phase of a CBF operation to prepare one or more STAs to receive data. In some examples, the channel sounding phase of the CBF operation (which may be a sequential sounding operation or a joint sounding operation) may include two or more channel sounding sequences. During each channel sounding sequence of the channel sounding phase of the CBF operation, an AP may transmit one or more ICFs to one or more STAs requesting the one or more STAs to transition from a first operating state (such as a low capability state) to a second operating state (such as a high capability state) to prepare to receive one or more frames as part of the channel sounding sequence. The one or more STAs may respond to the one or more ICFs with one or more ICRs acknowledging the ICF, indicating unavailability information, indicating that the one or more STAs are prepared to receive the one or more frames as part of the channel sounding sequence, or a combination thereof. As a result of the channel sounding phase, each AP in the OBSS may have CSI associated with each of the one or more STAs, which may be used to determine which clients will be served by which AP. During the transmission phase of the CBF operation, an ICF/ICR exchange may take place between each AP and one or more associated STAs to prepare the one or more associated STAs for reception of a downlink PPDU. In a first example, the ICF/ICR exchanges may take place in the OBSS staggered in time. An extended timeout duration may be configured so that none of the STAs revert to a default state (such as a low capability state) before reception of the downlink PPDU. In a second example, two or more ICF/ICR exchanges may be transmitted in parallel using a unified TA value, an OFDMA ICR, a BSS color field in a user information field, or a combination thereof. In a third example, the ICF may be sent by a single AP, and one or more ICRs may be received in an OFDMA mode. The ICF may be combined with a CBF response message at a shared AP to reduce overhead. In a fourth example, two or more ICFs and two or more ICRs may be transmitted in an OFDM mode. In implementations where a DPS STA or a CoEx STA acts as an AP in the CBF operation, an additional ICF/ICR exchange may occur, such as via a CBF trigger frame and a CBF response frame in a trigger-based PPDU format.

Particular aspects of the subject matter described in this disclosure can be implemented to realize one or more of the following potential benefits. In some examples, by including one or more ICF/ICR exchanges during the channel sounding phase and the transmission phase of a CBF operation, the described techniques can be used to reduce a quantity retransmissions due to a downlink PPDU being sent to an eMLSR STA via an inactive eMLSR link, to a CoEx STA that is unavailable, or to a DPS STA in a low capability mode.

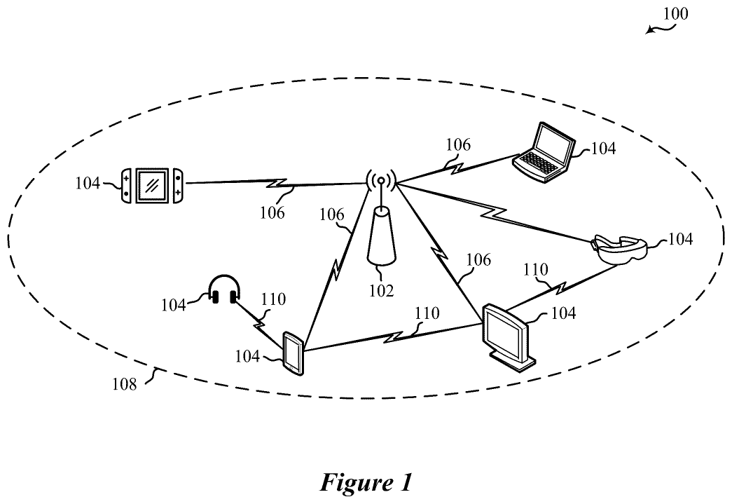

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4 -1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other benefits without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

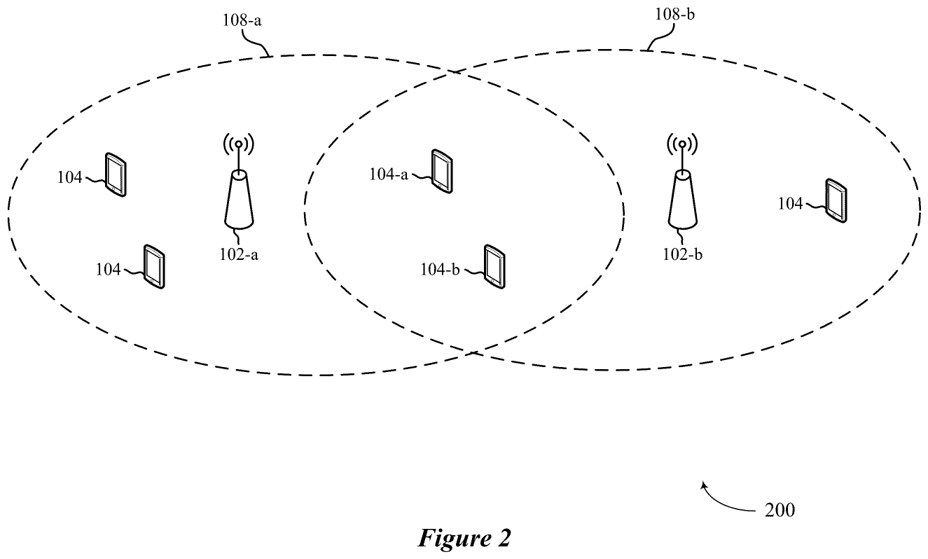

FIG. 2 shows an example of a signaling diagram 200 that supports operating state transitions in overlapping basic service sets. In some examples, the signaling diagram 200 may implement aspects of the wireless communications system 100. For example, the signaling diagram 200 includes a first AP 102-a, a second AP 102-b, a first STA 104-a, a second STA 104-b, and one or more other STAs 104, which may be examples of the corresponding devices described with reference to FIG. 1. Additionally, or alternatively, the APs 102 and the STAs 104 may each be examples of other types of wireless devices, such as a BS, a UE, or another type of transmitter or receiver. Thus, although aspects of the present disclosure are described with reference to APs 102 and STAs 104, it is understood that the described techniques may be performed by a wireless device different from an AP 102 and a STA 104. As described herein, operations performed by the APs 102 and the STAs 104 may be respectively performed by an AP 102, a STA 104, or another wireless device, and the examples shown should not be construed as limiting. Additionally, or alternatively, while two APs 102 and five STAs 104 are shown in the signaling diagram 200, more devices or fewer devices may be possible and the examples shown should not be construed as limiting.

The first AP 102-a and the second AP 102-b may be associated with a first BSS and a second BSS, respectively, where each BSS includes one or more STAs 104. For example, the first BSS may include one or more devices within a first coverage area 108-a (such as the AP 102-a, the STA 104-a, the STA 104-b, and one or more other STAs 104). Similarly, the second BSS may include one or more devices within a second coverage area 108-b (such as (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b. In some examples, the first AP 102-a may be a sharing AP and the second AP 102-b may be a shared AP, as discussed with reference to FIG. 1.

Devices in the signaling diagram 200 may support one or more coordinated beamforming (CBF) operations. A CBF operation may be a coordinated AP scheme that aims at simultaneously using the medium in two or more BSSs to maximize the system throughput. In some examples, the CBF operation may exploit one or more hardware capabilities of the AP 102-a and the AP 102-b (such as larger antenna arrays) to actively null signals at one or more clients of the OBSS using Tx beamforming. For example, the first AP 102-a may create a null at the second STA 104-b associated with the second AP 102-b and the second BSS, and the second AP 102-b may create a null at the first STA 104-a associated with the first AP 102-a and the first BSS. In this way, OBSS interference may be limited and successful reception may be achieved. However, such a CBF operation may involve CSI knowledge at the transmitters (such as the first AP 102-a and the second AP 102-b). For example, the AP 102-a may perform the CBF operation based on knowing the channel estimate between the AP 102-a and an associated client (such as STA 104) as well as between the AP 102-a and the OBSS client (such as the STA 104-a). The AP 102-a may be unable to perform the CBF operation without such channel estimates.

A CBF operation may be divided into two main phases: a channel sounding phase (such as CSI estimate collection) and a transmission phase (such as initial negotiation and initial handshaking between the first AP 102-a and the second AP 102-b in addition to data transmission). The objective of the channel sounding phase may be to make the CSI available at the OBSS APs 102 so that the OBSS AP 102 may actively null a signal at the OBSS client. For example, as a result of the channel sounding phase, the first AP 102-a may null an associated signal at the STA 104-b and the second AP 102-b may null an associated signal at the STA 104-a to reduce interference. During the transmission phase of the CBF operation, the first AP 102-a and the second AP 102-b (such as and any other APs 102 that may contribute to the OBSS) may agree on which clients (such as STAs 104) will be served by which AP 102, synchronize with each device, and proceed with simultaneous data transmission. During the simultaneous data transmission, the first AP 102-a and the second AP 102-b may use the CSI collected during the channel sounding phase in order to create the nulls in each respective signal.

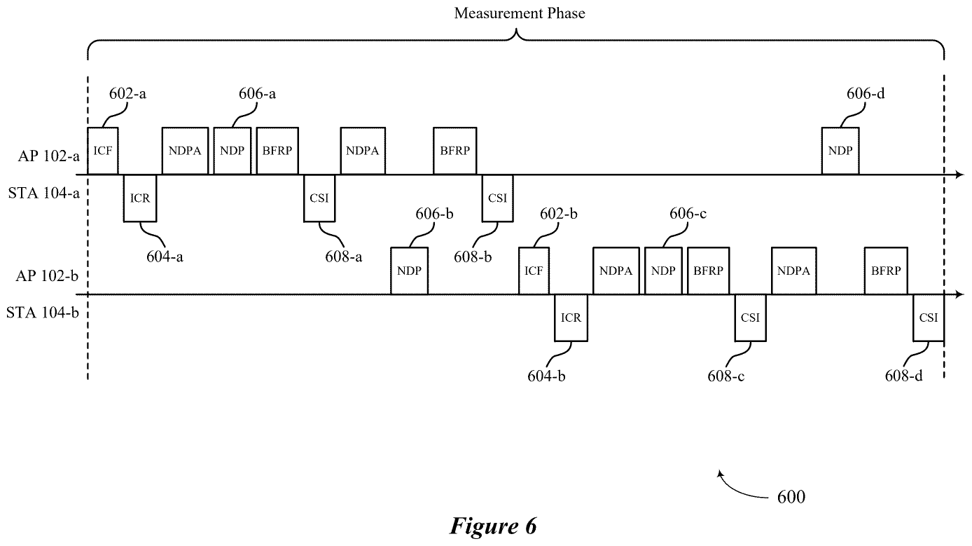

The channel sounding phase of the CBF operation may be a collaborative process performed by two or more APs 102 to collect CSI between each AP 102 and the OBSS clients (such as STAs 104). The general procedures of CBF channel sounding may follow the same concept of legacy in-BSS CBF channel sounding using the NDPA-NDP-BFRP-CSI frame sequence, as illustrated by at least FIG. 6.

CBF channel sounding may be sequential or joint. In sequential sounding, sounding is first performed for an associated AP 102 (such as the first AP 102-a) by transmitting a NDP and receiving CSI in response to a BFRP frame. Second, sounding is performed for an OBSS AP 102 (such as the second AP 102-b). For example, the associated AP 102-a may transmit an NDPA on behalf of the OBSS AP 102-b. The OBSS AP 102-b may transmit an NDP followed by a BFRP frame sent by the associated AP 102-a on behalf of the OBSS AP 102-b. Finally, the client (such as the AP 102) may report back associated CSI. The whole process (such as the sequential sounding process) may be repeated for all APs 102 participating in the channel sounding process. Joint channel sounding, in contrast, may aim to perform the sounding process in a more efficient way by performing CSI estimation to the associated AP 102-a as well as the OBSS AP 102-b simultaneously. A similar sounding sequence to that of sequential sounding may be used, but with the following differences. In joint channel sounding, one or more NDP frames may be sent jointly by both APs 102 at the same time (such as where CSI estimation to the two APs 102 can be done using a separate set of LTFs). Joint channel sounding may save up to three frame exchanges per AP 102 compared to sequential channel sounding, which may reduce the overhead of the sounding sequence.

During the transmission phase of the CBF operation, the two (such as or more) APs 102 may agree on which clients (such as STAs 104) will be served by each AP 102 and whether or not each AP 102 can null an associated Tx signal at the one or more clients of the other AP 102. Such an agreement may be achieved by means of the following three-way handshaking sequence. First, the sharing AP 102-a may share common preamble information in addition to which client (such as the first STA 104-a) or clients the sharing AP 102-a will serve via a CBF trigger frame (such as the CBF trigger frame may be associated with triggering one or more STAs 104 to transition from a first operating state to a second operating state). For example, in order to generate a common portion of later downlink PPDUs (such as CBF messaging) at the first AP 102-a and the second AP 102-b with at least a portion of the file headers in common, the APs 102 may agree on one or more parameters. Second, the shared AP 102-b may acknowledge that the AP 102-b can null an associated signal at the sharing AP 102-a client (such as the first STA 104-a) and declares which client the AP 102-b will serve (such as the second STA 104-b) via a CBF response frame (such as based on the CBF trigger frame). Third, the sharing AP 102-a may acknowledge that the AP 102-a can null an associated signal at the shared AP 102-b client (such as the second AP 102-b) via an ACK/Sync frame. The ACK/Sync frame may be used for synchronizing data transmissions, sharing information for creating a common preamble for downlink PPDUs, or both.

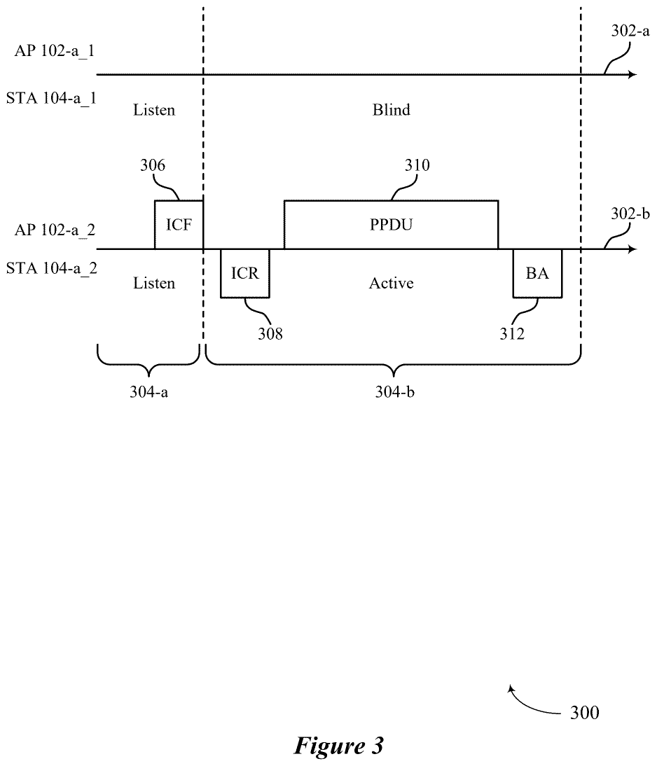

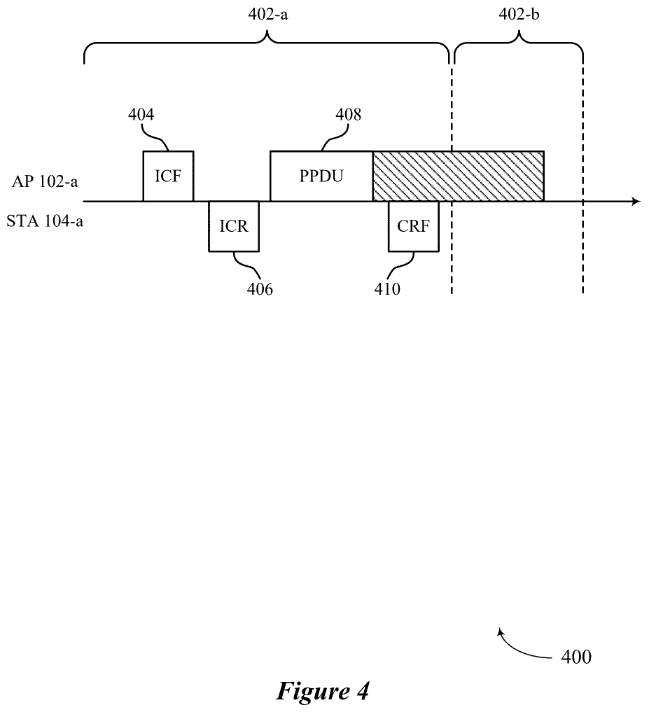

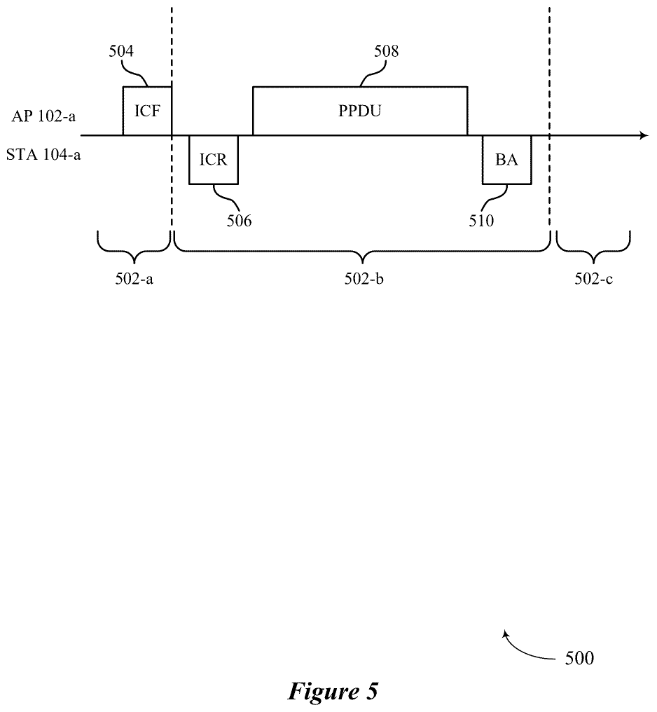

In the discussed channel sounding and transmission sequences so far, client readiness for data reception may be assumed. However, in some scenarios, the client STA 104 may be unable or unavailable to receive data immediately. For example, the STA 104 may be an eMLSR STA 104 that may need to activate a communication link before data reception, as described in more detail with reference to FIG. 3. Additionally, or alternatively, the STA 104 may be in a CoEx mode, where the client STA 104 may be unavailable for a brief period due to engagement with CoEx transmission going in the background (such as a mobile device may be playing a video using Wi-Fi while also being connected to an audio device via Bluetooth in the background), as described in more detail with reference to FIG. 4. Additionally, or alternatively, the STA 104 may be operating in a DPS mode in which additional time is used to transition from low capability operation (such as a power saving mode, a low power mode, a default mode) to full capability operation, as described in more detail with reference to FIG. 5. Other scenarios in which the client STA 104 may be unable to immediately receive data also may occur. Because of these and other examples, an ICF/ICR exchange may take place at an appropriate time to ensure, for example, that an eMLSR STA 104 activates the appropriate link and is ready for frame reception; that a CoEx STA 104 reports an expected future unavailability so that the first AP 102-a, the second AP 102-b, or both may account for the unavailability; that a STA 104 operating in a DPS mode may transition to full capability operation and may be ready for frame reception; that a STA 104 may transition from a first operating state to a second operating state that is prepared for frame reception; or a combination thereof.

FIG. 3 shows an example of a signaling diagram 300 that supports operating state transitions in overlapping basic service sets. In some examples, the signaling diagram 300 may implement aspects of the wireless communications system 100 and the signaling diagram 200. For example, the signaling diagram 300 includes a first AP 102-a_1, a second AP 102-a_2, a first STA 104-a_1, and a second STA 104-a_2, which may be examples of the corresponding devices described with reference to FIGS. 1 and 2. Additionally, or alternatively, the APs 102 and the STAs 104 may each be examples of other types of wireless devices, such as a BS, a UE, or another type of transmitter or receiver. Thus, although aspects of the present disclosure are described with reference to APs 102 and STAs 104, it is understood that the described techniques may be performed by a wireless device different from an AP 102 and a STA 104. As described herein, operations performed by the APs 102 and the STAs 104 may be respectively performed by an AP 102, a STA 104, or another wireless device, and the examples shown should not be construed as limiting. Additionally, or alternatively, while two APs 102 and two STAs 104 are shown in the signaling diagram 300, more devices may be possible and the examples shown should not be construed as limiting.

The signaling diagram 300 illustrates an example in which the first STA 104-a_1 and the second STA 104-a_2 are eMLSR STAs, or STAs in an eMLSR mode, belonging to a same non-AP MLD. Similarly, the first AP 102-a_1 and the second AP 102-a_2 may belong to a same AP MLD. For example, the first AP 102-a_1 and the first STA 104-a_1 may be connected via a first link 302-a (such as an eMLSR link) while the second AP 102-a_2 and the second STA 104-a_2 may be connected via a second link 302-b (such as an eMLSR link). At a first time period 304-a, the first STA 104-a_1 and the second STA 104-a_2 may both be in a listen mode, in an inactive mode, or performing a listen operation. While in the listen mode, the second STA 104-a_2 may receive, from the second AP 102-a_2, an ICF 306 that activates the second link 302-b. That is, in response to the ICF 306, the second STA 104-a_2 may enter an active mode (such as active state) or perform active operations during a second time period 304-b. During the second time period 304-b, the second STA 104-a_2 may transmit, to the second AP 102-a_2, an ICR frame 308 responding to the ICF 306 and indicating that the second STA 104-a_2 is ready to receive one or more data messages, such as the downlink PPDU 310. In some examples, the second STA 104-a_2 may receive one or more downlink PPDUs 310 and transmit a block acknowledgment (BA) 312 in response.

The signaling diagram 300, in which the STA 104-a_2 is an eMLSR STA, illustrates one example in which the STAs 104 are not ready to receive data immediately from one or more APs 102, and uses an ICF/ICR exchange to prepare for a channel sounding sequence, a transmission sequence, or both of a CBF operation by transitioning from a first operating state (such as a listen state) to a second operating state (such as an active state). A second example, in which a STA 104 is in a CoEx mode, is described with reference to FIG. 4 and a third example in which a STA 104 is in a DPS mode is described with reference to FIG. 5.

FIG. 4 shows an example of a signaling diagram 400 that supports operating state transitions in overlapping basic service sets. In some examples, the signaling diagram 400 may implement aspects of the wireless communications system 100 and the signaling diagram 200. For example, the signaling diagram 400 includes an AP 102-a and a STA 104-a, which may be examples of the corresponding devices described with reference to FIGS. 1 and 2. The AP 102-a may be referred to as a peer STA (such as acting as an AP 102) and the STA 104-a may be in a CoEx mode and may experience in-device coexistence (IDC) interference (such as interference as a result of the CoEx mode that causes one or more periods of unavailability at the STA 104-a). Additionally, or alternatively, the AP 102-a and the STA 104-a may each be examples of other types of wireless devices, such as a UE or another type of transmitter or receiver. Thus, although aspects of the present disclosure are described with reference to an AP 102 and a STA 104, it is understood that the described techniques may be performed by a wireless device different from an AP 102 and a STA 104. As described herein, operations performed by the AP 102-a and the STA 104-a may be performed by an AP 102, a STA 104, or another wireless device, and the examples shown should not be construed as limiting. Additionally, or alternatively, while an AP 102 and a STA 104 are shown in the signaling diagram 400, more devices may be possible and the examples shown should not be construed as limiting.

The signaling diagram 400 illustrates an example in which the STA 104-a is in a CoEx mode. For example, the AP 102-a may transmit, to the STA 104-a, an indication that the STA 104-a is to operate in the CoEx mode. While operating in the CoEx mode, the STA 104-a may be available for data message reception during a first time period 402-a and may be unavailable for data message reception during a second time period 402-b. However, the AP 102-a may be unaware of the unavailability of the STA 104-a during the second time period 402-b and may schedule data message transmissions (such as such as transmission of the PPDU 408) at least partially overlapping the second time period 402-b while the STA 104-a is unavailable to receive the PPDU 408. To avoid transmitting the PPDU 408 while the STA 104-a is unavailable, the AP 102-a may transmit, to the STA 104-a, an ICF 404 that solicits or requests unavailability information. Based on the ICF 404, the STA 104-a may transmit, to the AP 102-a, an ICR 406 that includes the unavailability information (such as indicating that the STA 104-a is available for downlink data transmissions during the first time period 402-a and is unavailable for downlink data transmissions during the second time period 402-b). Based on the ICR 406, the AP 102-a may adjust a duration of the PPDU 408 (such as truncate the PPDU 408) to a level that allows for the PPDU 408 and a response (such as the CRF 410 including unavailability information, a BA bitmap, or both) within the first time period 402-a while the STA 104-a is available.

The signaling diagram 400, in which the STA 104-a is in a CoEx mode, illustrates a second example in which the STA 104-a is not ready to receive data immediately from one or more APs 102 (such as the AP 102-a), and uses an ICF/ICR exchange to prepare a channel sounding sequence, a transmission sequence, or both of a CBF operation by transmitting unavailability information. A first example, in which a STA 104 is in an eMLSR STA, is described with reference to FIG. 3 and a third example in which a STA 104 is in a DPS mode is described with reference to FIG. 5.

FIG. 5 shows an example of a signaling diagram 500 that supports operating state transitions in overlapping basic service sets. In some examples, the signaling diagram 500 may implement aspects of the wireless communications system 100 and the signaling diagram 200. For example, the signaling diagram 500 includes an AP 102-a and a STA 104-a, which may be examples of the corresponding devices described with reference to FIGS. 1 and 2. The AP 102-a may be referred to as a peer STA (such as acting as an AP 102) and the STA 104-a may be referred to as a DPS client. Additionally, or alternatively, the AP 102-a and the STA 104-a may each be examples of other types of wireless devices, such as a UE or another type of transmitter or receiver. Thus, although aspects of the present disclosure are described with reference to an AP 102 and a STA 104, it is understood that the described techniques may be performed by a wireless device different from an AP 102 and a STA 104. As described herein, operations performed by the STAs 104 may be performed by an AP 102, a STA 104, or another wireless device, and the examples shown should not be construed as limiting. Additionally, or alternatively, while an AP 102 and a STA 104 are shown in the signaling diagram 500, more devices may be possible and the examples shown should not be construed as limiting.

The signaling diagram 500 illustrates an example in which at least the STA 104-a is in a DPS mode. For example, the STA 104-a may be in a low capability mode by default (such as in a first time period 502-a) until receiving an ICF 504 from the AP 102-a that requests the STA 104-a to transition to a high capability mode. The STA 104-a may enter the high capability mode for a second time period 502-b based on the ICF 504 and may transmit, to the AP 102-a, an ICR 506. The ICF frame may provide a padding period that may be exploited by the DPS STA (such as the STA 104-a) to make the transition between the low capability and high capability states. In some examples, reception of the ICR 506 at the AP 102-a may indicate a transition from the low capability state to the high capability state. The STA 104-a may receive a PPDU 508 from the AP 102-a and may transmit a BA 510 during the second time period 502-b while in the high capability mode. In some examples, the STA 104-a may transition back to the low capability mode (such as the default mode) during a third time period 502-c in order to save power.

The signaling diagram 500, in which the STA 104-a is in a DPS mode, illustrates a third example in which the STA 104-a is not ready to receive data immediately from one or more APs 102 (such as the AP 102-a), and uses an ICF/ICR exchange to prepare for a channel sounding sequence, a transmission sequence, or both of a CBF operation by transitioning from a first operating state (such as a low capability state) to a second operating state (such as a high capability state). A first example, in which a STA 104 is in an eMLSR STA, is described with reference to FIG. 3 and a third example in which a STA 104 is in a DPS mode is described with reference to FIG. 5.

FIG. 6 shows an example of a signaling diagram 600 that supports operating state transitions in overlapping basic service sets. In some examples, the signaling diagram 600 may implement aspects of the wireless communications system 100 and the signaling diagram 200. For example, the signaling diagram 600 includes a first AP 102-a, a second AP 102-b, a first STA 104-a, a second STA 104-b, which may be examples of the corresponding devices described with reference to FIG. 1. In some examples, steps in the signaling diagram 600 may include additional features not mentioned below, or further steps may be added. Additionally, or alternatively, while two APs 102 and two STAs 104 are shown in the signaling diagram 600, more devices may be possible and the examples shown should not be construed as limiting.

The first AP 102-a and the second AP 102-b may be associated with a first BSS and a second BSS, respectively, where each BSS includes one or more STAs 104. For example, the first BSS may include one or more devices within a first coverage area 108 (such as the AP 102-a, the STA 104-a, the STA 104-b, and one or more other STAs 104). Similarly, the second BSS may include one or more devices within a second coverage area 108 (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b. In some examples, the first AP 102-a may be a sharing AP and the second AP 102-b may be a shared AP, as discussed with reference to FIG. 1.

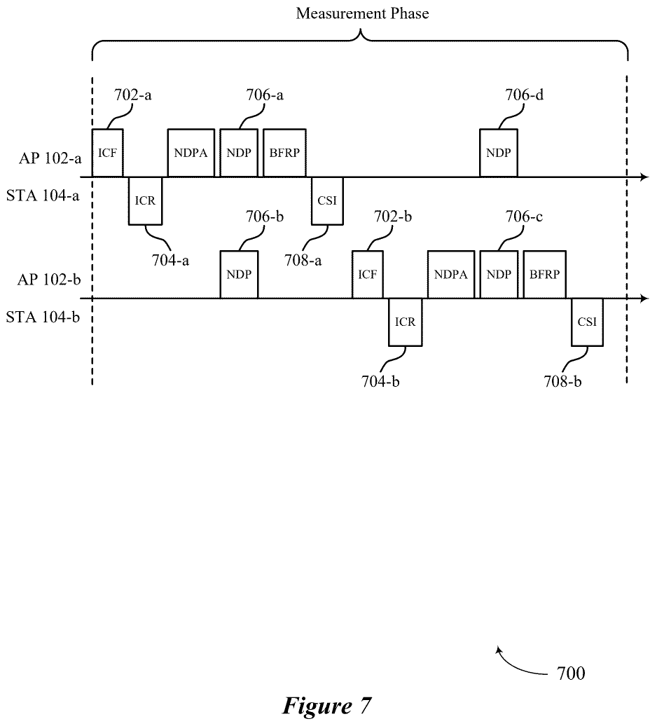

The devices in the signaling diagram 600 may support a sequential channel sounding sequence for eMLSR STAs 104 (such as described in more detail with reference to FIG. 3), STAs 104 in a CoEx mode (such as described in more detail with reference to FIG. 4), STAs 104 in a DPS mode (such as described in more detail with reference to FIG. 5), and other STAs 104 that may not be immediately available for downlink data reception from one or more APs 102. The techniques described herein also may extend to joint channel sounding, as described in more detail with reference to FIG. 7. For a generic framework that supports each implementation (such as eMLSR STAs 104, CoEx STAs 104, DPS STAs 104, and other STAs 104), an exchange of an ICF 602 and an ICR 604 may occur at the beginning (such as before transmission of one or more NDPAs) of the sounding sequence for each BSS to 1.) enable a link for active operation for eMLSR STAs 104, 2.) solicit future unavailability information for a CoEx STA 104, and 3.) upgrade or transition a DPS STA 104 to full capability.

In some implementations, the first AP 102-a and the second AP 102-b may collect CSI 608 from each BSS in the OBSS. For example, the first AP 102-a may collect 1.) CSI 608-a associated with a first channel (which may be referred to as a channel link) between the first STA 104-a and the first AP 102-a, and 2.) CSI 608-b associated with a second channel between the first STA 104-a and the second AP 102-b. Similarly, the second AP 102-b may collect 1.) CSI 608-c associated with a third channel between the second STA 104-b and the second AP 102-b, and 2.) CSI 608-d associated with a fourth channel between the second STA 104-b and the first AP 102-a.

However, the first STA 104-a, the second STA 104-b, or both may be in a first operating state in which STA 104 is unable to immediately perform the CBF channel sounding sequence in the OBSS. For example, the STA 104-a may be an eMLSR STA 104, a CoEx STA 104, a DPS STA 104, or a combination thereof and may therefore be unable to perform the channel sounding sequence without initial preparation. For example, the first AP 102-a may transmit, to the first STA 104-a, an ICF 602-a that prepares the STA 104-a to receive an NDPA, an NDP 606, and other CBF channel sounding sequence frames (such as instructing the STA 104-a to transition from a first operating state to a second operating state). For example, if the STA 104-a is an eMLSR STA 104, the ICF 602-a may instruct the STA 104-a to activate an eMLSR link (such as the first operating state includes an inactive eMLSR link, and the second operating state include an active eMLSR link, as described in more detail with reference to FIG. 3). If the STA 104-a is a CoEx STA 104, the ICF 602-a may instruct the STA 104-a to provide unavailability information that will be taken into consideration when the AP(s) construct PPDU(s) before sending the PPDU(s) to the STA (such as discussed with reference to FIG. 4). If the STA 104-a is a DPS STA 104, the ICF 602-a may instruct the STA 104-a to upgrade to full capability operation (such as the first operating state includes low capability, reduced capability, or low power operation, and the second operating state includes high capability, full capability, or high power operation, as described in more detail with reference to FIG. 5) before one or more active transmissions. The contents of the ICF 602-a may be different depending on whether the STA 104-a is an eMLSR STA 104, a CoEx STA 104, a DPS STA 104, or another type of STA 104.

Based on the ICF 602-a, the first STA 104-a may transition to the second operating state (such as an active eMLSR link, an available CoEx mode, a full capability DPS mode) and transmit, to the first AP 102-a, an ICR 604-a acknowledging the ICF 602-a and indicating preparedness to receive CBF channel sounding frames. In some examples, if the STA 104-a is a CoEx STA 104, the ICR 604-a may include unavailability information that the AP 102-a may use to transmit channel sounding frames (such as adjust the timing of one or more PPDUs according to the unavailability information). Based on the ICF 602-a and the ICR 604-a, the first AP 102-a may perform a CBF channel sounding sequence. For example, the AP 102-a may transmit an NDPA to announce to the client (such as the first STA 104-a) that the AP 102-a will send an NDP 606-a that the client is to use to estimate the channel response. The first AP 102-a may subsequently transmit the NDP 606-a and a BFRP to pull the CSI 608-a from the client. The CSI 608-a may describe a first channel between the first STA 104-a and the first AP 102-a. After the first CSI 608-a transmission by the first STA 104-a, the first AP 102-a may transmit a second NDPA to the first STA 104-a on behalf of the second AP 102-b (such as the channel sounding sequence may be transparent to the client, such that the first STA 104-a does not know that a second CSI 608-b will be with respect to an AP 102 that is not the AP 102 associated with the first STA 104-a). For example, the second NDPA frame may indicate, to the first STA 104-a, that the second AP 102-b is to transmit an NDP 606-b frame that the first STA 104-a is to use to estimate a second channel between the first STA 104-a and the second AP 102-b. After a second BFRP frame from the first AP 102-a, the first STA 104-a may transmit the second CSI 608-b.

The second half of the measurement phase may mirror the first half of the measurement phase, but performed by the second AP 102-b (e.g., an OBSS AP) and the second STA 104-b associated with the second BSS. For example, the second AP 102-b may transmit, to the second STA 104-b, a second ICF 602-b instructing the STA 104-b to transition from a first operating state to a second operating state in preparation for the channel sounding sequence (such as or requesting unavailability information, or both). The second STA 104-b may transition to the second operating state and may respond with a second ICR 604-b that acknowledges the ICF 602-b, indicates that the STA 104-b is in the second operating state, provides unavailability information (such as if the STA 104-b is a CoEx STA 104), or a combination thereof. The second AP 102-b may transmit a third NDPA, followed by transmission of a third NDP 606-c. After receiving a third BFRP, the second STA 104-b may transmit, to the second AP 102-b, third CSI 608-c associated with a third channel between the second AP 102-b and the second STA 104-b. The second AP 102-b may transmit a fourth NDPA to the second STA 104-b. The first AP 102-a may transmit, to the second STA 104-b, a fourth NDP 606-d that the second STA 104-b is to use to estimate a fourth channel between the first AP 102-a and the second STA 104-b. After receiving a fourth BFRP from the second AP 102-b, the second STA 104-b may transmit fourth CSI 608-d associated with the fourth channel between the first AP 102-a and the second STA 104-b.

Each frame in the signaling diagram 600 (and in other signaling diagrams described herein) may be separated in time from neighboring frames by a short interframe space (SIFS) (such as a delay in microseconds). However, the sounding sequence for the first BSS and the second BSS can be separated in two different TXOPs without any constraints on time separation between the CSI frame 608-b and the ICF frame 602-b.

As a result of the measurement phase illustrated by the signaling diagram 600, the first AP 102-a may have the CSI 608-a (such as associated with the first channel between the first AP 102-a and the first STA 104-a) and the CSI 608-b (such as associated with the second channel between the second AP 102-b and the first STA 104-a). Similarly, the second AP 102-b may have the CSI 608-c (such as associated with the third channel between the second AP 102-b and the second STA 104-b) and the CSI 608-d (such as associated with the fourth channel between the first AP 102-a and the second STA 104-b). Thus, the devices in the signaling diagram 600 may perform CBF channel sounding in an OBSS.

As a reminder, the first AP 102-a may transmit, to one or more STAs 104 of a set of multiple STAs 104 (such as including the STA 104-a), an ICF 602-a to trigger the one or more STAs 104 to transition from a first operating state to a second operating state. The transmission of the ICF 602-a may be associated with a set of multiple channel sounding procedures. The exchange of an ICF 602 and an ICR 604 may occur prior to each channel sounding procedure of the set of multiple channel sounding procedures. The first AP 102-a may monitor, during a first channel sounding procedure of the set of multiple channel sounding procedures, for the ICR 604-a from the one or more STAs 104 (such as the STA 104-a) based on the ICF 602-a. The AP 102-a may transmit, to a set of one or more STAs 104 associated with the AP 102-a, one or more frames during the first channel sounding procedure (such as the NDPA, the NDP 606-a, and the BFRP). The AP 102-a may trigger the second AP 102-b to transmit, to the set of one or more STAs 104 associated with the first AP 102-a (such as including the STA 104-a), one or more frames during the first channel sounding procedure (such as the NDP 606-b). The AP 102-a may receive, from the set of one or more STAs associated with the first AP 102-a, a CSI frame (such as the CSI 608-a, the CSI 608-b, or both).

FIG. 7 shows an example of a signaling diagram 700 that supports operating state transitions in overlapping basic service sets. In some examples, the signaling diagram 700 may implement aspects of the wireless communications system 100 and the signaling diagram 200. For example, the signaling diagram 700 includes a first AP 102-a, a second AP 102-b, a first STA 104-a, a second STA 104-b, which may be examples of the corresponding devices described with reference to FIG. 1. In some examples, steps in the signaling diagram 700 may include additional features not mentioned below, or further steps may be added. Additionally, or alternatively, while two APs 102 and two STAs 104 are shown in the signaling diagram 700, more devices may be possible and the examples shown should not be construed as limiting.

The first AP 102-a and the second AP 102-b may be associated with a first BSS and a second BSS, respectively, where each BSS includes one or more STAs 104. For example, the first BSS may include one or more devices within a first coverage area 108 (such as the AP 102-a, the STA 104-a, the STA 104-b, and one or more other STAs 104). Similarly, the second BSS may include one or more devices within a second coverage area 108 (such as (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b. In some examples, the first AP 102-a may be a sharing AP and the second AP 102-b may be a shared AP, as discussed with reference to FIG. 1.

While the signaling diagram 600 illustrates an example of sequential CBF channel sounding, the signaling diagram 700 illustrates an example of joint CBF channel sounding where the STAs 104 may be eMLSR STAs 104, CoEx STAs 104, DPS STAs 104, or a combination thereof. For example, devices in the signaling diagram 700 may perform the CBF sounding process in a more efficient way than illustrated in the signaling diagram 600 by performing the CSI estimation to the associated AP 102-a as well as the OBSS AP 102-b simultaneously. The joint CBF channel sounding sequence of the signaling diagram 700 may be similar the sequential CBF channel sounding sequence of the signaling diagram 600, except that one or more NDP frames may be sent jointly (such as in parallel, simultaneously) by both the first AP 102-a and the second AP 102-b at the same time (such as where CSI estimation to the two APs 102 can be done using a separate set of LTFs). The joint channel sounding sequence of the signaling diagram 700 may save up to three frame exchanges per AP 102 compared to the sequential channel sounding sequence of the signaling diagram 600, which may reduce the overhead of the sounding sequence.

For example, the ICF 702-a, the ICF 702-b, the ICR 704-a, and the ICR 704-b may contain similar information to the ICF 602-a, the ICF 602-b, the ICR 604-a, and the ICR 604-b, respectively, as described with reference to FIG. 6. The APs 102 may transmit the respective ICFs 702 to the respective STAs 104 to instruct the respective STAs 104 to transition from a first operating state to a second operating state, to transmit availability information, or both. The STAs 104 may transmit the respective ICRs 704 to the APs 102 to acknowledge reception of the ICFs 702, and indicate that the STAs 104 have transitioned from the first operating state to the second operating state, to indicate unavailability information associated with the STAs 104, or a combination thereof. For example, if the first STA 104-a is an eMLSR STA 104, the ICF 702-a may instruct the STA 104-a to activate an eMLSR link between the AP 102-a and the STA 104-a, and the ICR 704-a may indicate that the eMLSR link is activated. In another example, if the first STA 104-a is a CoEx STA 104, the ICF 702-a may request, and the ICR 704-a may provide, unavailability information associated with a duration that the STA 104-a is unavailable to receive transmissions from the AP 102-a. The AP 102-a may use the indicated unavailability information to schedule one or more frames, such as the BFRP or a PPDU. In a third example, if the AP 102-b is a DPS STA 104, the ICF 702-b may instruct the STA 104-b to transition from a low capability mode to a high capability mode associated with higher power consumption. The ICR 704-b may indicate, to the AP 102-b, that the STA 104-b has transitioned to the high capability mode and is ready to receive one or more frames (such as the NDP 706-c).

Based on receiving the ICR 704-a as part of a first joint channel sounding sequence (such as or the first portion of a joint channel sounding sequence), the AP 102-a may transmit, to the STA 104-a, an NDPA that prepares the STA 104-a to receive both the NDP 706-a from the AP 102-a and the NDP 706-b from the AP 102-b simultaneously (such as in parallel, concurrently, in separate sets of LTFs). The STA 104-a may receive the NDP 706-a and the NDP 706-b (such as and a BFRP from the AP 102-a), and may use the NDPs 706 to collect and transmit, to the AP 102-a, the CSI 708-a including CSI associated with a first channel between the first AP 102-a and the first STA 104-a and a second channel between the second AP 102-b and the first STA 104-a.

In a second joint channel sounding sequence (such as or a second portion of the joint channel sounding sequence) associated with the second STA 104-b, the second STA 104-b may receive the ICF 702-b instructing the STA 104-b to transition from the first operating state to the second operating state, may transition from the first operating state to the second operating state, and may transmit the ICR 704-b indicating the transition (such as and indicating unavailability information, if the STA 104-b is a CoEx STA 104). Based on receiving the ICR 704-b, the AP 102-b may transmit, to the STA 104-b, an NDPA that prepares the STA 104-b to receive both the NDP 706-c from the AP 102-b and the NDP 706-d from the AP 102-a simultaneously (such as in parallel, in separate sets of LTFs). The STA 104-b may receive the NDP 706-c, the NDP 706-d, and a BFRP from the AP 102-b), and may use the NDPs 706 to collect and transmit, to the AP 102-b, the CSI 708-b including CSI associated with a third channel between the first AP 102-a and the second STA 104-b and a fourth channel between the second AP 102-b and the second STA 104-b.

Each frame in the signaling diagram 700 (such as and in other signaling diagrams described herein) may be separated in time from neighboring frames by a short interframe space (SIFS) (such as a delay in microseconds). However, the sounding sequence for the first BSS and the second BSS can be separated in two different TXOPs without any constraints on time separation between the CSI frame 608-b and the ICF frame 602-b.

As a result of the measurement phase illustrated by the signaling diagram 700, the first AP 102-a may have the CSI 708-a (such as including CSI associated with the first channel between the first AP 102-a and the first STA 104-a and including CSI associated with the second channel between the second AP 102-b and the first STA 104-a) as a result of the first joint channel sounding sequence (such as or the first portion of the joint channel sounding sequence) associated with the first BSS. Similarly, the second AP 102-b may have the CSI 708-b (such as including CSI associated with the third channel between the first AP 102-a and the second STA 104-b and including CSI associated with the fourth channel between the second AP 102-b and the second STA 104-b) as a result of the second joint channel sounding sequence (such as or the second portion of the joint channel sounding sequence) associated with the second BSS. Thus, the devices in the signaling diagram 700 may perform joint CBF channel sounding in an OBSS.

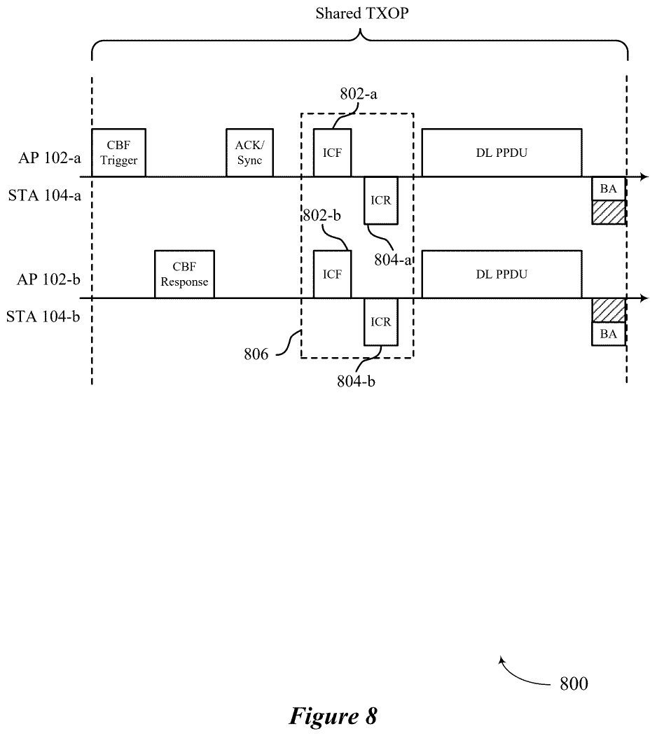

FIG. 8 shows an example of a signaling diagram 800 that supports operating state transitions in overlapping basic service sets. In some examples, the signaling diagram 800 may implement aspects of the wireless communications system 100 and the signaling diagram 200. For example, the signaling diagram 800 includes a first AP 102-a, a second AP 102-b, a first STA 104-a, a second STA 104-b, which may be examples of the corresponding devices described with reference to FIG. 1. In some examples, steps in the signaling diagram 800 may include additional features not mentioned below, or further steps may be added. Additionally, or alternatively, while two APs 102 and two STAs 104 are shown in the signaling diagram 800, more devices may be possible and the examples shown should not be construed as limiting.

The first AP 102-a and the second AP 102-b may be associated with a first BSS and a second BSS, respectively, where each BSS includes one or more STAs 104. For example, the first BSS may include one or more devices within a first coverage area 108 (such as the AP 102-a, the STA 104-a, the STA 104-b, and one or more other STAs 104). Similarly, the second BSS may include one or more devices within a second coverage area 108 (such as (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b. In some examples, the first AP 102-a may be a sharing AP and the second AP 102-b may be a shared AP, as discussed with reference to FIG. 2.

The signaling diagram 800 may illustrate how an ICF/ICR frame exchange may occur between each AP 102 and one or more respective scheduled clients (such as between the first AP 102-a and the first STA 104-a, between the second AP 102-b and the second STA 104-b) during the ICF/ICR preparation period 806 to prepare the one or more clients for reception of one or more CBF downlink PPDUs. For example, after CBF communications initiation via a three-way handshake (such as including a CBF trigger frame, a CBF response frame, and one or more ACK/Sync frames, as described in more detail with reference to FIG. 1), the first AP 102-a may transmit, to the first STA 104-a, an ICF 802-a, and the first STA 104-a may transmit, to the first AP 102-a, an ICR 804-a. Similarly, the second AP 102-b may transmit, to the second STA 104-b, an ICF 802-b, and the second STA 104-b may transmit, to the second AP 102-b, an ICR 804-b.

The ICFs 802 and the ICRs 804 may contain information similar to corresponding frames discussed with reference to FIG. 3-7. For example, if the STA 104-a is an eMLSR STA 104, the ICF 802-a may instruct the STA 104-a to activate an eMLSR link between the first AP 102-a and the first STA 104-a (such as the first operating state includes an eMLSR link in listen mode, and the second operating state include an active eMLSR link, as described in more detail with reference to FIG. 3). If the STA 104-a is a CoEx STA 104, the ICF 802-a may instruct the STA 104-a to provide unavailability information (such as discussed with reference to FIG. 4). If the STA 104-a is a DPS STA 104, the ICF 802-a may instruct the STA 104-a to upgrade to full capability operation (such as the first operating state includes low capability, reduced capability, or low power operation, and the second operating state includes high capability, full capability, or high power operation, as described in more detail with reference to FIG. 5) before one or more active transmissions. The contents of the ICF 802-a may be different depending on whether the STA 104-a is an eMLSR STA 104, a CoEx STA 104, a DPS STA 104, or another type of STA 104. The ICR 804-a may indicate to the first AP 102-a that the first STA 104-a has transitioned from the first operating state to the second operating state and is prepared to receive a scheduled downlink PPDU. Similarly, the ICR 804-b may indicate to the second AP 102-b that the second STA 104-b has transitioned from the first operating state to the second operating state and is prepared to receive a scheduled downlink PPDU. If either STA 104 is a CoEx STA 104, the associated ICR 804 may include unavailability information that the respective AP 102 may use to schedule the downlink PPDU.

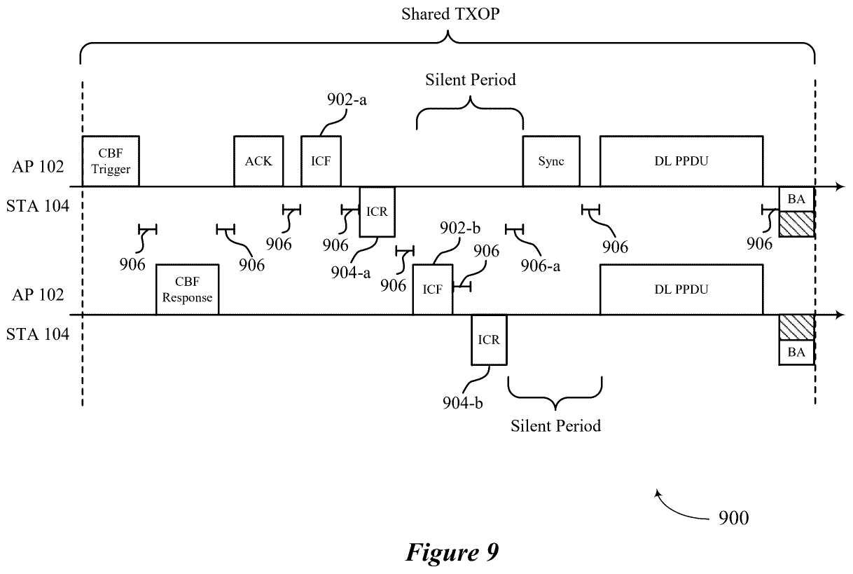

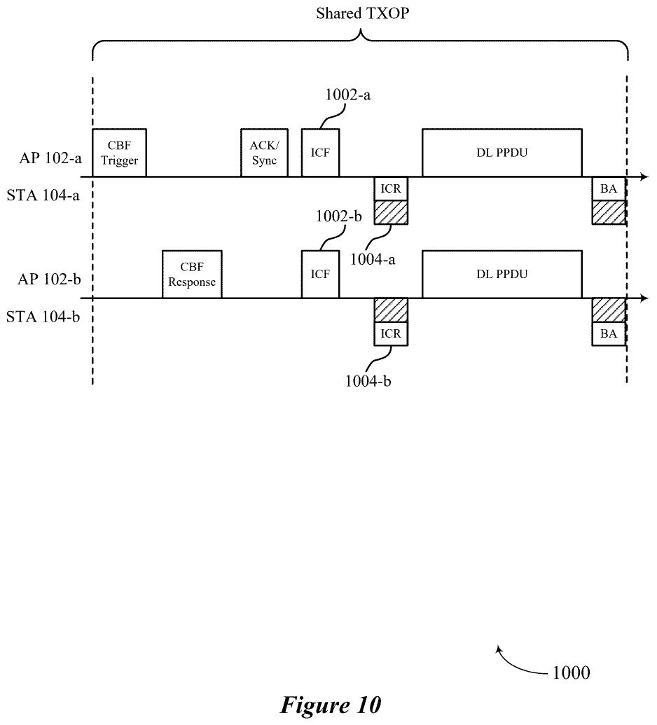

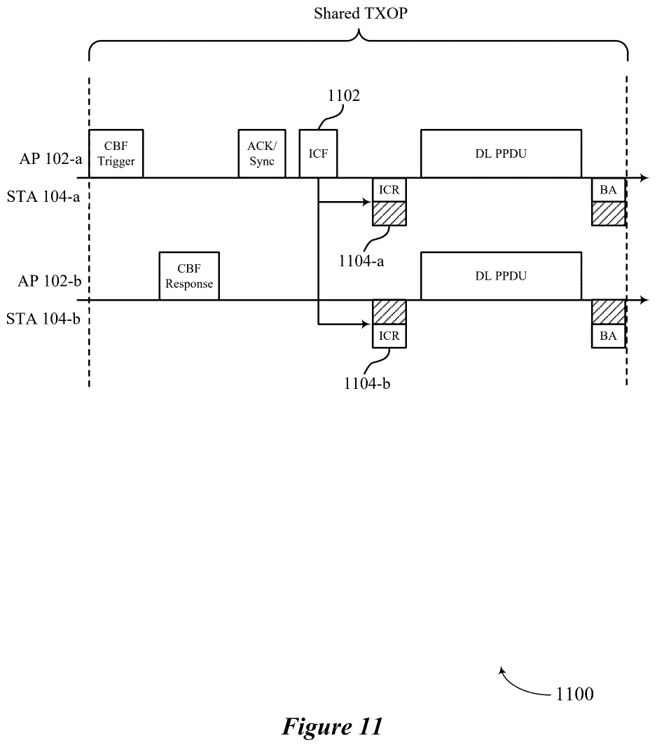

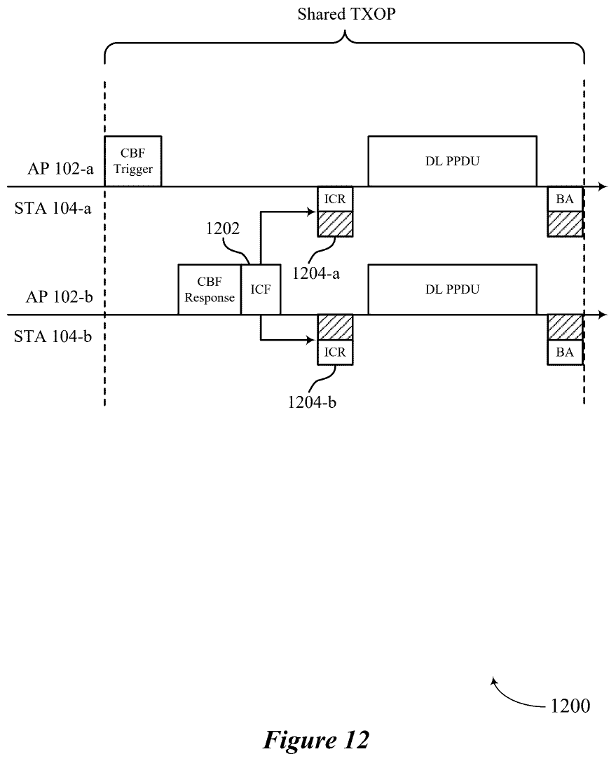

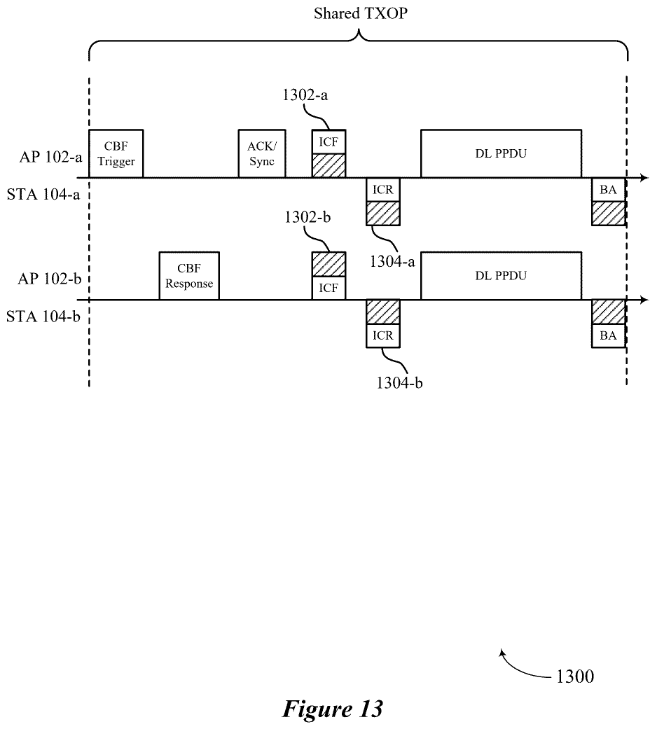

One challenge with the signaling diagram 800 is to avoid interference between the first ICF 802-a and the second ICF 802-b and between the first ICR 804-a and the second ICR 804-b sent in the two BSSs (such as the OBSS) to ensure successful reception and decoding of all frames (such as at each wireless device). To ensure successful decoding, at least four ICF/ICR transmission schemes are described with reference to FIG. 9-13. For example, in a first transmission scheme, ICF/ICR exchanges may be staggered in the two BSSs, as described in more detail with reference to FIG. 9. In a second transmission scheme, wireless devices may employ parallel and identical ICF 802 transmission with a unified transmitter address (TA) and OFDMA ICR 804, as described in more detail with reference to FIG. 10. In a third transmission scheme, a single AP 102 may transmit a single ICF 802 (such as rather than two parallel ICF 802 transmissions by two APs 102) and one or more STAs 104 may respond with an OFDMA ICR 804, as described in more detail with reference to FIGS. 11 and 12. In a fourth transmission scheme, one or more ICFs 802 and one or more ICRs 804 may be sent in OFDMA (such as in an OFDMA mode), as described in more detail with reference to FIG. 13.

In some examples, the first ICF 802-a, the second ICF 802-b, or both may be transmitted concurrently or staggered in time by the first AP 102-a and the second AP 102-b, respectively, based on the ACK/syn message (such as an acknowledgment message, a synchronization message, or both). In some examples, the first AP 102-a may transmit, to the second AP 102-b, a synchronization message, where a first data message (such as downlink PPDU) is transmitted to the one or more STAs 104 (such as the STA 104-a) concurrently with a second data message by the second AP 102-b (such as to the second STA 104-b) based on the synchronization message.

FIG. 9 shows an example of a signaling diagram 900 that supports operating state transitions in overlapping basic service sets. In some examples, the signaling diagram 900 may implement aspects of the wireless communications system 100 and the signaling diagram 200. For example, the signaling diagram 900 includes a first AP 102-a, a second AP 102-b, a first STA 104-a, a second STA 104-b, which may be examples of the corresponding devices described with reference to FIG. 1. In some examples, steps in the signaling diagram 900 may include additional features not mentioned below, or further steps may be added. Additionally, or alternatively, while two APs 102 and two STAs 104 are shown in the signaling diagram 900, more devices may be possible and the examples shown should not be construed as limiting. The wireless devices illustrated by the signaling diagram 900 may be part of an OBSS, including a first BSS associated with the first AP 102-a and a second BSS associated with the second AP 102-b.

As introduced with reference to FIG. 8, the signaling diagram 900 illustrates a first example transmission scheme in which the ICF/ICR exchanges are time staggered across the two BSSs. Interference can be avoided by sending ICF/ICR frames sequentially in the two BSSs. However, such staggering may result in silent periods between each AP 102 and one or more associated scheduled STAs 104, which may cause the one or more STAs 104 to revert to default settings (such as a first operational state) as a result of interpreting the silent period as the AP 102 no longer involving the STA 104 in any further active transmissions. For example, this issue may be relevant for an eMLSR STA 104, which may deactivate an eMLSR link with an associated AP 102 (such as re-enter a listening mode) when receiving no frames during the silent period. Similarly, a DPS STA 104 may revert to a low capability (such as default, low power) mode when receiving no frames during the silent period. To avoid this issue, UHR STAs 104 operating in an eMLSR mode or a DPS mode may be configured to extend a timeout duration after which the STA 104 may revert to one or more default settings (such as a first operational state, a listening mode, a low capability mode).

For example, the first STA 104-a and the second STA 104-b may be configured (such as via a 1-bit field in an ICF 902-a, an ICF 902-b indicated by the APs 102, or another ICF 902 and understood by the UHR STAs 104, or via other signaling), based on the ICF 902-a, with two timeout period durations that can be used: 1.) a normal duration that may be used in normal operation (such as non-CBF operation), and 2.) an extended duration that may be used while operating in a CBF mode (such as triggered by the CBF trigger and acknowledged by the CBF response). In some examples, one or more of the APs 102 may transmit, based on an ICF 902 and to one or more STAs 104, an indication to switch from a default timeout period duration to an extended timeout period duration. The indication may indicate that the one or more STAs 104 are permitted to switch back to the first operating state after the extended timeout period duration if no frames are received during the extended timeout period duration.

Note that an ACK/Sync frame (such as described with reference to FIG. 2) may be split into two or more frames: 1.) an ACK frame sent before sending the ICF/ICR (such as between the CBF response and the ICF 902-a), and 2.) a sync frame sent right before the downlink PPDUs (such as between the ICR 904-b and the downlink PPDU).

As part of the staggered ICF/ICR exchange, the first AP 102-a may transmit an ICF 902-a (such as including a 1-bit field instructing the STA 104-a to use the extended duration) to the first STA 104-a in a first time occasion, during which the second AP 102-b is silent. The first STA 104-a may transmit an ICR 904-a to the first AP 102-a. During a second time occasion (such as while the first AP 102-a is silent), the second AP 102-b may transmit an ICF 902-b to the second STA 104-b (such as including a 1-bit field instructing the STA 104-b to use the extended duration). Finally, the second STA 104-b may transmit an ICR 904-b to the second AP 102-b. Because of the indicated extended durations, the first STA 104-a and the second STA 104-b may be prepared (such as eMLSR links are activated, STAs 104 are in high capability mode, or both despite the silent periods) to receive the downlink PPDUs fully in sync in terms of frequency and time.

Each frame of the signaling diagram 900 may be separated from one or more other frames (such as neighboring frames, or frames immediately preceding or immediately following each frame) by one or more SIFS 906. For example, the SIFS 906-a may separate the ICR 904-b from the Sync frame in time.

FIG. 10 shows an example of a signaling diagram 1000 that supports operating state transitions in overlapping basic service sets. In some examples, the signaling diagram 1000 may implement aspects of the wireless communications system 100 and the signaling diagram 200. For example, the signaling diagram 1000 includes a first AP 102-a, a second AP 102-b, a first STA 104-a, a second STA 104-b, which may be examples of the corresponding devices described with reference to FIG. 1. In some examples, steps in the signaling diagram 1000 may include additional features not mentioned below, or further steps may be added. Additionally, or alternatively, while two APs 102 and two STAs 104 are shown in the signaling diagram 1000, more devices may be possible and the examples shown should not be construed as limiting. The wireless devices illustrated by the signaling diagram 1000 may be part of an OBSS, including a first BSS associated with the first AP 102-a and a second BSS associated with the second AP 102-b.

As introduced with reference to FIG. 8, the signaling diagram 1000 illustrates a second example transmission scheme with parallel and identical ICF transmission using a unified TA value and OFDMA ICR. For this option, the signaling diagram 1000 illustrates the transmission of two parallel and identical ICF 1002 frames by the two APs 102. One or more ICR 1004 frames can be sent back by the STAs in OFDMA mode with different RUs dedicated to STAs 104 associated with different APs 102. For example, an ICF 1002 may indicate, to one or more STAs 104, one or more RUs (such as frequencies) for each STA 104 to use to transmit a respective ICR 1004. The first AP 102-a may indicate, via the ICF 1002-a, that the first STA 104-a is to use a first RU to transmit the ICR 1004-a. The second AP 102-b may indicate, via the ICF 1002-b, that the second STA 104-b is to use a second RU to transmit the ICR 1004-b. The ICF 1002-a and the ICF 1002-b may be identical or contain the same information, and may be transmitted concurrently or synchronously. The first RU (such as or set of RUs) may be different from the second RU (such as or set of RUs).

In some examples, the first AP 102-a and the second AP 102-b may exchange STA-related information to enable the creation of the identical ICFs 1002-a and 1002-b. For example, the first AP 102-a may transmit first STA information to the second AP 102-b, and the second AP 102-b may transmit second STA information to the first AP 102-a. The STA information may include, for example, a padding duration used by the first STA 104-a and the second STA 104-b scheduled by the first AP 102-a and the second AP 102-b. Each of the two APs can then use the same value of padding which should be the maximum to cover both clients requirement. In some examples, the STA information may be included in the CBF trigger frame, the CBF response frame, the ACK/Sync frame, or one or more other frames.

Despite this approach avoiding the additional overhead from the first example transmission scheme described with reference to FIG. 9, this second example transmission scheme includes other challenges. For example, BSS color values (such as in a BSS color field in the PHY header) and TA values (such as in a TA field in the MAC header) may be different for the first AP 102-a and the second AP 102-b, which goes against the idea of identical ICFs 1002. Additionally, or alternatively, an AID collision between the first STA 104-a and the second STA 104-b may be possible. For example, the first ICF 1002-a and the second ICF 1002-b, which may be trigger frame variants, may specify an RU allocation for each STA 104 in separate user information fields. If these user information fields are identified with a same AID (such as because the STAs 104 associated with the first AP 102-a and the STAs 104 associated with the second AP 102-b have a same AID, such as 25), then the STAs 104 may be confused and see two different RU assignments for their AID.

To overcome the issues related to BSS color, if the ICFs 1002 are going to be sent in a non-HT format, then BSS color does not exist in the PHY header and the issue is naturally solved. Otherwise, a BSS color field may be set to 0 in both the first ICF 1002-a sent by the first AP 102-a and the second ICF 1002-b sent by the second AP 102-b. If both BSS color fields associated with the first ICF 1002-a and the second ICF 1002-b are set to 0, there may not be an identicality issue between the first ICF 1002-a and the second ICF 1002-b. To overcome the issues related to TA value (such as BSS ID/MAC address), the AP 102-a and the AP 102-b may agree to use a unified TA value that may be a first TA value associated with the first AP 102-a (such as the sharing AP 102), a second TA value associated with a third AP 102 (such as a master AP 102, which may be specified early on in the CBF establishment phase between the first AP 102-a and the second AP 102-b), or a third TA value (such as a special TA value) that may be agreed upon during the CBF establishment phase between the first AP 102-a and the second AP 102-b during the channel sounding phase (such as before the transmission phase illustrated by the signaling diagram 1000). The STA 104-a and the STA 104-b may both be notified to respond to frames with the TA address set to the unified TA value, which may occur during the channel sounding phase (such as before the transmission phase illustrated by the signaling diagram 1000). For example, the first AP 102-a may transmit, to the AP 102-b and one or more STAs 104, an earlier indication to respond to a frame including the unified TA value. The ICF and the ICR may be based on the indication and based on the unified TA value. To overcome issues related to the first STA 104-a and the second STA 104-b sharing a same AID value, the BSS color (such as a 6-bit identifier associated with each AP 102) may be added as an additional identifier within the user information field to resolve AID ambiguity (such as based on the first AP 102-a and the second AP 102-b sharing a same AID). For example, the first STA 104-a may discard a transmission associated with a BSS color associated with the second AP 102-b, even if the transmission is associated with a same AID value as the STA 104-a.

FIG. 11 shows an example of a signaling diagram 1100 that supports operating state transitions in overlapping basic service sets. In some examples, the signaling diagram 1100 may implement aspects of the wireless communications system 100 and the signaling diagram 200. For example, the signaling diagram 1100 includes a first AP 102-a, a second AP 102-b, a first STA 104-a, a second STA 104-b, which may be examples of the corresponding devices described with reference to FIG. 1. In some examples, steps in the signaling diagram 1100 may include additional features not mentioned below, or further steps may be added. Additionally, or alternatively, while two APs 102 and two STAs 104 are shown in the signaling diagram 1100, more devices may be possible and the examples shown should not be construed as limiting. The wireless devices illustrated by the signaling diagram 1100 may be part of an OBSS, including a first BSS associated with the first AP 102-a and a second BSS associated with the second AP 102-b.

As introduced with reference to FIG. 8, the signaling diagram 1100 illustrates a first variant of a third example transmission scheme with a single ICF 1102. The second example transmission scheme in which two APs 102 transmitted identical and simultaneous ICFs 1002 (such as described in more detail with reference to FIG. 10) may not be successful unless the first ICF 1002-a and the second ICF 1002-b are strictly time synchronized. To avoid such a time synchronization requirement, the ICF 1102 may be sent only from one AP 102 (such as the first AP 102-a) addressing scheduled STAs 104 of both APs 104. In some examples, the second AP 102-b may refrain from transmitting an ICF 1102. The AP 102 to send the ICF 1102 may be the sharing AP 102 (such as the first AP 102-a) or a master AP 102 defined at an earlier stage (such as during the channel sounding phase or earlier, during the CBF relation establishment phase between two APs 102). For example, the first AP 102-a may transmit the ICF 1102 to the first STA 104-a (such as with an indication to transmit an ICR 1104-a in a first RU) and may transmit the ICF 1102 to the second STA 104-b (such as with an indication to transmit an ICR 1104-b in a second RU).

Because the ICF 1102 includes a single TA value and a single BSS color (such as 0 or another value), this third example transmission scheme may inherit the two issues discussed with reference to FIG. 10. The solutions discussed with reference to FIG. 10 also may apply to the signaling diagram 1100. For example, to overcome the issues related to BSS color, if the ICF 1102 is going to be sent in a non-HT format, then BSS color may not be included in the PHY header. Otherwise, a BSS color field may be set to 0 in the ICF 1102. To overcome the issues related to TA value (such as MAC ID), the AP 102-a may use a unified TA value that may be a first TA value associated with the first AP 102-a (such as the sharing AP 102), a second TA value associated with a third AP 102 (such as a master AP 102, which may be specified early on in the CBF establishment phase between the first AP 102-a and the second AP 102-b), or a third TA value (such as a special TA value) that may be agreed upon during the CBF establishment phase between the first AP 102-a and the second AP 102-b during the channel sounding phase (such as before the transmission phase illustrated by the signaling diagram 1000). The STA 104-a and the STA 104-b may both be notified to respond to frames with the TA address set to the unified TA value, which may occur during the channel sounding phase (such as before the transmission phase illustrated by the signaling diagram 1000). To overcome issues related to the first STA 104-a and the second STA 104-b sharing a same AID value, the BSS color (such as a 6-bit identifier associated with the AP 102-a) may be added as an additional identifier within the user information field to resolve AID ambiguity. For example, the first STA 104-a may discard a transmission associated with a BSS color associated with the second AP 102-b, even if the transmission is associated with a same AID value as the AP 102-a. For example, the first AP 102-b may transmit the ICF 1102 to the first STA 104-a (such as with an indication to transmit an ICR 1104-a in a first RU) and may transmit the ICF 1102 to the second STA 104-b (such as with an indication to transmit an ICR 1104-b in a second RU).

In some examples, the first AP 102-a may transmit, using the unified TA value, the ICF 1102 to a first subset of one or more STAs 104 (such as the first STA 104-a) associated with the first AP 102-a. The first AP 102-a also may transmit, using the unified TA value, the ICF 1102 to a second subset of one or more STAs 104 (such as including the second STA 104-b) associated with the second AP 102-b. The ICR 1104-a may be received in a first set of RUs different from a second set of RUs used to transmit the second ICR 1104-b by the STA 104-b (such as associated with the second AP 102-b).

FIG. 12 shows an example of a signaling diagram 1200 that supports operating state transitions in overlapping basic service sets. In some examples, the signaling diagram 1200 may implement aspects of the wireless communications system 100 and the signaling diagram 200. For example, the signaling diagram 1200 includes a first AP 102-a, a second AP 102-b, a first STA 104-a, a second STA 104-b, which may be examples of the corresponding devices described with reference to FIG. 1. In some examples, steps in the signaling diagram 1200 may include additional features not mentioned below, or further steps may be added. Additionally, or alternatively, while two APs 102 and two STAs 104 are shown in the signaling diagram 1200, more devices may be possible and the examples shown should not be construed as limiting. The wireless devices illustrated by the signaling diagram 1200 may be part of an OBSS, including a first BSS associated with the first AP 102-a and a second BSS associated with the second AP 102-b.

As introduced with reference to FIG. 8, the signaling diagram 1200 illustrates a second variant of a third example transmission scheme with a single ICF 1202. For example, the shared AP 102 (such as the second AP 102-b, a shared AP 102) may transmit the ICF 1202. This may provide a chance to combine the ICF 1202 and the CBF response frames into one frame (such as an aggregate PPDU) to reduce overhead and improve the efficiency of the transmission sequence. For example, the second AP 102-b may transmit the CBF response and the ICF 1202 in a same frame. The second AP 102-b may receive a first ICR 1204-a from the first STA 104-a in a first set of RUs, and may receive a second ICR 1204-b from the second STA 104-b in a second set of RUs different from the first set of RUs. It may be assumed that none of the APs 102 (such as the first AP 102-a nor the second AP 102-b) may acknowledge the client choice of the other AP 102. For example, it may be assumed that each AP 102 will choose a STA 104 to be scheduled with confidence that the chosen STA 104 will be supported by the other AP 102 (such as the AP 102-b may assume that the AP 102-a would ACK the CBF response). The first STA 104-a may be notified (such as configured) to respond to the ICF 1202 from the second AP 102-b (such as during the channel sounding phase). For example, the second AP 102-b may transmit the ICF 1202 to the first STA 104-a (such as with an indication to transmit an ICR 1204-a in a first RU) and may transmit the ICF 1202 to the second STA 104-b (such as with an indication to transmit an ICR 1204-b in a second RU).

The same issues and solutions regarding BSS color and TA value discussed with reference to FIGS. 10 and 11 may apply to the signaling diagram 1200. While no ACK/Sync frame is shown in the signaling diagram 1200, a sync frame may be sent between the ICRs 1204 and the downlink PPDU.

FIG. 13 shows an example of a signaling diagram 1300 that supports operating state transitions in overlapping basic service sets. In some examples, the signaling diagram 1300 may implement aspects of the wireless communications system 100 and the signaling diagram 200. For example, the signaling diagram 1300 includes a first AP 102-a, a second AP 102-b, a first STA 104-a, a second STA 104-b, which may be examples of the corresponding devices described with reference to FIG. 1. In some examples, steps in the signaling diagram 1300 may include additional features not mentioned below, or further steps may be added. Additionally, or alternatively, while two APs 102 and two STAs 104 are shown in the signaling diagram 1300, more devices may be possible and the examples shown should not be construed as limiting. The wireless devices illustrated by the signaling diagram 1300 may be part of an OBSS, including a first BSS associated with the first AP 102-a and a second BSS associated with the second AP 102-b.

As introduced with reference to FIG. 8, the signaling diagram 1300 illustrates a fourth example transmission scheme with ICFs 1302 and ICRs 1304 both sent in OFDMA. For example, the signaling diagram 1300 takes a different approach by parallelizing a first ICF 1302-a and a second ICF 1302-b in the frequency domain, where both the first ICF 1302-a and the second ICF 1302-b may be sent in the OFDMA mode using different sets of RUs. Similarly, the ICR 1304-a and the ICR 1304-b may be sent by the STA 104-a and the STA 104-b, respectively, may be assigned different RUs that are indicated in the first ICF 1302-a and the second ICF 1302-b, respectively. In some examples, the STA 104-a and the STA 104-b may be notified early (such as during the channel sounding phase) to expect the first ICF 1302-a and the second ICF 1302-b to be sent on a specific set of RUs.

For example, the STA 104-a may be notified, during the channel sounding phase, to expect the ICF 1302-a using a first RU, and the STA 104-b may be notified, during the channel sounding phase, to expect the ICF 1302-b using a second RU. In accordance with the notifications, the STA 104-a may transmit the ICF 1302-a using the first RU, where the ICF 1302-a indicates the STA 104-a to use a third RU. Simultaneously, the AP 102-b may transmit the ICF 1302-b using the second RU, where the ICF 1302-b indicates the STA 104-b to use a fourth RU. The STA 104-a may simultaneously transmit the ICR 1304-a using the third RU while the STA 104-b may transmit the ICR 1304-b using the fourth RU, in accordance with the first ICF 1302-a and the second ICF 1302-b.

In some examples, the first AP 102-a may transmit, via a first set of RUs, the ICF 1302-a concurrent with transmission of a second ICF 1302-b by the second AP 102-b via a second set of RUs. The AP 102-a may receive, via a third set of RUs, the ICR 1304-a concurrent with transmission of a second ICR 1304-b by the STA 104-b associated with the second AP 102-b via a fourth set of RUs.

In this fourth example transmission scheme, there may not be a requirement for sending the first ICF 1302-a and the second ICF 1302-b with unified TA values or BSS color. Moreover, the AP 102-a and the AP 102-b may schedule the STA 104-a and the STA 104-b with a same AID seamlessly.

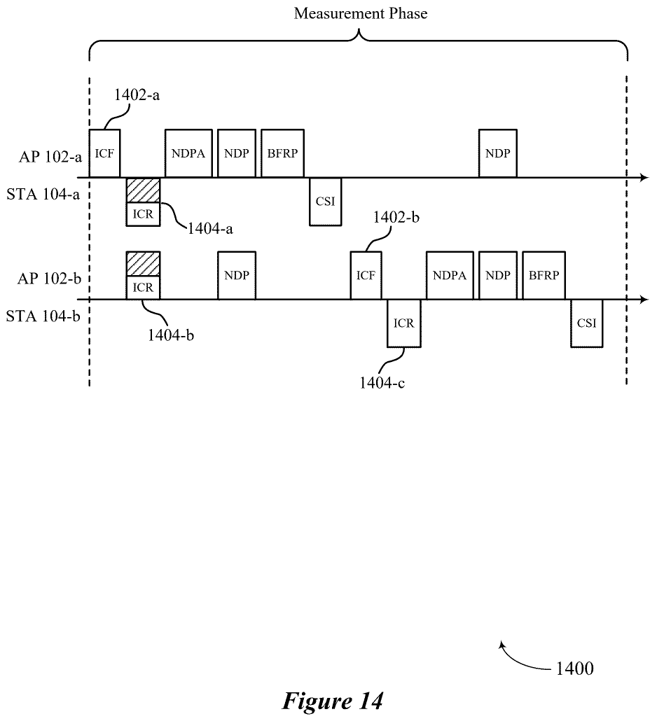

FIG. 14 shows an example of a signaling diagram 1400 that supports operating state transitions in overlapping basic service sets. In some examples, the signaling diagram 1400 may implement aspects of the wireless communications system 100 and the signaling diagram 200. For example, the signaling diagram 1400 includes a first AP 102-a, a second AP 102-b, a first STA 104-a, a second STA 104-b, which may be examples of the corresponding devices described with reference to FIG. 1. In some examples, steps in the signaling diagram 1200 may include additional features not mentioned below, or further steps may be added. Additionally, or alternatively, while two APs 102 and two STAs 104 are shown in the signaling diagram 1200, more devices may be possible and the examples shown should not be construed as limiting. The wireless devices illustrated by the signaling diagram 1200 may be part of an OBSS, including a first BSS associated with the first AP 102-a and a second BSS associated with the second AP 102-b.

In some examples, the second AP 102 (such as the AP 102-b, which may be an AP 102, such as a soft AP 102 or a mobile AP 102) may be in a CoEx mode or a DPS mode, hence the possibility of the second AP 102 using an ICF/ICR exchange prior to frame exchange should be taken into consideration as well. For example, the AP 102-b may be a cell phone with a hotspot feature enabled. For the transmission sequence, the CBF trigger frame and the CBF response frames may act as an ICF and an ICR, respectively. For a first channel sounding sequence, the sounding sequence initiating AP 102 (such as the AP 102-a) can send an ICF 1402-a soliciting one or more ICR frames to be sent in the trigger-based physical layer protocol (such as TB PPDU) format from one or more STAs 104 associated with the AP 102-a (such as the STA 104-a) and from one or more APs (such as the AP 102-b). The AP 102-a may transmit, to the second AP 102-b, a request for the second AP 102-b to transition from a first operating state to a second operating state (such as the operating states described with reference to FIGS. 3 through 5). The AP 102-a may receive an ICR 1404-a from the STA 104-a using a first RU (such as indicated by the ICF 1402-a), and may receive an ICR 1404-b from the AP 102-b using a second RU (such as indicated by the ICF 1402-a). In a second channel sounding sequence, the second AP 102-b may transmit an ICF 1402-b to the STA 104-b, and may receive an ICR 1404-c. While the signaling diagram 1400 illustrates an example of joint channel sounding, the sequence may be extended to sequential sounding, as discussed with reference to FIG. 6. One or more APs 102 responding with frames in the TB PPDU format may be enabled.

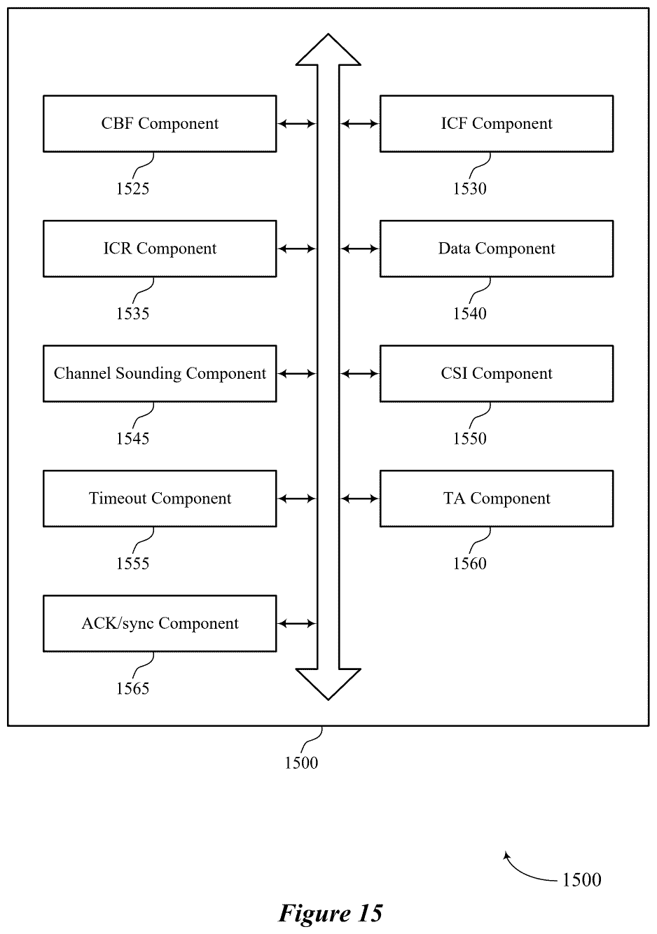

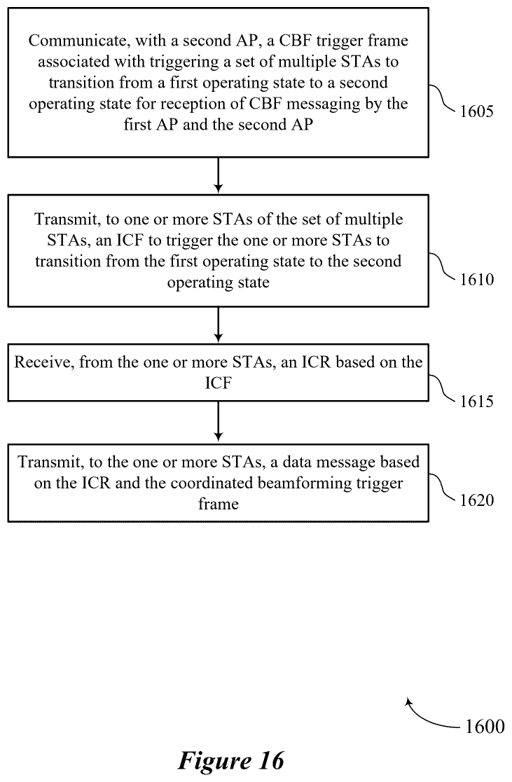

FIG. 15 shows a block diagram of an example wireless communication device 1500 that supports operating state transitions in overlapping basic service sets. In some examples, the wireless communication device 1500 is configured to perform the processes 1600, 1700, and 1800 described with reference to FIGS. 16, 17, and 18, respectively. The wireless communication device 1500 may include one or more chips, SoCs, chipsets, packages, components or devices that individually or collectively constitute or include a processing system. The processing system may interface with other components of the wireless communication device 1500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1500 may transmit the information output from the chip. In such an example, the second interface may refer to an interface between the processing system of the chip and a reception component, such that the wireless communication device 1500 may receive information that is then passed to the processing system. In some such examples, the first interface also may obtain information, such as from the transmission component, and the second interface also may output information, such as to the reception component.

The processing system of the wireless communication device 1500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1500 can be configurable or configured for use in an AP, such as the AP 102 described with reference to FIG. 1. In some other examples, the wireless communication device 1500 can be an AP that includes such a processing system and other components including multiple antennas. The wireless communication device 1500 is capable of transmitting and receiving wireless communications in the form of, for example, wireless packets. For example, the wireless communication device 1500 can be configurable or configured to transmit and receive packets in the form of physical layer PPDUs and MPDUs conforming to one or more of the IEEE 802.11 family of wireless communication protocol standards. In some other examples, the wireless communication device 1500 can be configurable or configured to transmit and receive signals and communications conforming to one or more 3GPP specifications including those for 5G NR or 6G. In some examples, the wireless communication device 1500 also includes or can be coupled with one or more application processors which may be further coupled with one or more other memories. In some examples, the wireless communication device 1500 further includes at least one external network interface coupled with the processing system that enables communication with a core network or backhaul network that enables the wireless communication device 1500 to gain access to external networks including the Internet.

The wireless communication device 1500 includes a CBF component 1525, an ICF component 1530, an ICR component 1535, a data component 1540, a channel sounding component 1545, a CSI component 1550, a timeout component 1555, a TA component 1560, and an ACK/sync component 1565. Portions of one or more of the CBF component 1525, the ICF component 1530, the ICR component 1535, the data component 1540, the channel sounding component 1545, the CSI component 1550, the timeout component 1555, the TA component 1560, and the ACK/sync component 1565 may be implemented at least in part in hardware or firmware. For example, one or more of the CBF component 1525, the ICF component 1530, the ICR component 1535, the data component 1540, the channel sounding component 1545, the CSI component 1550, the timeout component 1555, the TA component 1560, and the ACK/sync component 1565 may be implemented at least in part by at least a processor or a modem. In some examples, portions of one or more of the CBF component 1525, the ICF component 1530, the ICR component 1535, the data component 1540, the channel sounding component 1545, the CSI component 1550, the timeout component 1555, the TA component 1560, and the ACK/sync component 1565 may be implemented at least in part by a processor and software in the form of processor-executable code stored in memory.

The wireless communication device 1500 may support wireless communications in accordance with examples as disclosed herein. The CBF component 1525 is configurable or configured to communicate, with a second AP, a coordinated beamforming trigger frame associated with triggering a set of multiple stations (STAs) to transition from a first operating state to a second operating state for reception of coordinated beamformed messaging by the first AP and the second AP. The ICF component 1530 is configurable or configured to transmit, to one or more STAs of the set of multiple STAs, an initial control frame (ICF) to trigger the one or more STAs to transition from the first operating state to the second operating state. The ICR component 1535 is configurable or configured to receive, from the one or more STAs, an initial control response (ICR) based on the ICF. The data component 1540 is configurable or configured to transmit, to the one or more STAs, a data message based on the ICR and the coordinated beamforming trigger frame.

In some examples, to support communicating the coordinated beamforming trigger frame, the CBF component 1525 is configurable or configured to transmit, to the second AP, the coordinated beamforming trigger frame. In some examples, to support communicating the coordinated beamforming trigger frame, the CBF component 1525 is configurable or configured to receive, from the second AP, a coordinated beamforming response frame based on the coordinated beamforming trigger frame.

In some examples, to support communicating the coordinated beamforming trigger frame, the CBF component 1525 is configurable or configured to receive, from the second AP, the coordinated beamforming trigger frame. In some examples, to support communicating the coordinated beamforming trigger frame, the CBF component 1525 is configurable or configured to transmit, to the second AP, a coordinated beamforming response frame based on the coordinated beamforming trigger frame.

In some examples, the ICF is transmitted before a first time occasion associated with transmission of a second ICF by the second AP. In some examples, the first AP skips transmission during the first time occasion and during a second time occasion associated with transmission of a second ICR by a STA associated with the second AP.

In some examples, the timeout component 1555 is configurable or configured to transmit, to the one or more STAs of the set of multiple STAs, an indication to switch from a default timeout period duration to an extended timeout period duration based on the ICF, where the indication indicates that the one or more STAs of the set of multiple STAs are permitted to switch back to the first operating state after the extended timeout period duration if no frames are received during the extended timeout period duration.

In some examples, to support transmitting the ICF, the ICF component 1530 is configurable or configured to transmit the ICF concurrent with transmission of a second ICF by the second AP, where the ICF and the second ICF are identical and are transmitted synchronously, and where the ICR is received in a first set of resource units different from a second set of resource units used to transmit a second ICR by a STA associated with the second AP.

In some examples, the TA component 1560 is configurable or configured to transmit, to the one or more STAs of the set of multiple STAs, an earlier indication to respond to a frame including a unified transmitter address value, where the ICF is transmitted with the unified transmitter address value and where the ICR is received based on the indication and the unified transmitter address value.

In some examples, a basic service set color field is excluded from a physical header or set to 0.

In some examples, a basic service set color is indicated in a user information field based on the first AP and the second AP sharing a same association identifier (AID).

In some examples, the ICF component 1530 is configurable or configured to transmit, to the second AP, first STA information and receive, from the second AP, second STA information, where the ICF is transmitted concurrently with transmission of a second ICF by the second AP based on the first STA information and the second STA information, and where the ICF and the second ICF are identical and are transmitted synchronously.

In some examples, to support transmitting the ICF, the TA component 1560 is configurable or configured to transmit, using a unified transmission address value, the ICF to a first subset of one or more STAs of the set of multiple STAs, where the first subset of one or more STAs is associated with the first AP, and where the ICR is received in a first set of resource units different from a second set of resource units used to transmit a second ICR by a STA associated with the second AP. In some examples, to support transmitting the ICF, the TA component 1560 is configurable or configured to transmit, using the unified transmission address value, the ICF to a second subset of one or more STAs of the set of multiple STAs, where the second subset of one or more STAs is associated with the second AP.

In some examples, a coordinated beamforming response frame and the ICF frame are transmitted in a same frame. In some examples, the ICR is received in a first set of resource units different from a second set of resource units used to transmit a second ICR by a STA associated with the second AP.

In some examples, to support transmitting the ICF, the ICF component 1530 is configurable or configured to transmit, via a first set of resource units, the ICF concurrent with transmission of a second ICF by the second AP via a second set of resource units. In some examples, to support transmitting the ICF, the ICR component 1535 is configurable or configured to receive, via a third set of resource units, the ICR concurrent with transmission of a second ICR by a STA associated with the second AP via a fourth set of resource units.

In some examples, the ACK/sync component 1565 is configurable or configured to transmit, to the second AP, an acknowledgment message, a synchronization message, or both, where the ICF and a second ICF are transmitted concurrently or staggered in time by the first AP and the second AP to the one or more STAs based on the acknowledgment message, the synchronization message, or both.

In some examples, the ACK/sync component 1565 is configurable or configured to transmit, to the second AP, a synchronization message, where a first data message is transmitted to the one or more STAs concurrently with a second data message by the second AP based on the synchronization message.

In some examples, the ACK/sync component 1565 is configurable or configured to receive, from the second AP, an acknowledgment message, a synchronization message, or both, where the ICF and a second ICF are transmitted concurrently or staggered in time by the first AP and the second AP to the one or more STAs based on the acknowledgment message, the synchronization message, or both.

In some examples, the ACK/sync component 1565 is configurable or configured to receive, from the second AP, a synchronization message, where a second data message is transmitted to the one or more STAs concurrently with a first data message by the first AP based on the synchronization message.

Additionally, or alternatively, the wireless communication device 1500 may support wireless communications in accordance with examples as disclosed herein. In some examples, the ICF component 1530 is configurable or configured to transmit, to one or more STAs of a set of multiple STAs, an initial control frame (ICF) to trigger the one or more STAs to transition from a first operating state to a second operating state, where transmission of the ICF is associated with a set of multiple channel sounding procedures. In some examples, the ICR component 1535 is configurable or configured to monitor, during a first channel sounding procedure of the set of multiple channel sounding procedures, for an ICR from the one or more STAs based on the ICF, where exchange of the ICF and the ICR occurs prior to each channel sounding procedure of the set of multiple channel sounding procedures. The channel sounding component 1545 is configurable or configured to transmit, to a set of one or more first STAs associated with the first AP, one or more frames during the first channel sounding procedure. In some examples, the channel sounding component 1545 is configurable or configured to trigger the second AP to transmit, to the set of one or more first STAs associated with the first AP, one or more frames during the first channel sounding procedure. The CSI component 1550 is configurable or configured to receive, from the set of one or more first STAs associated with the first AP, a channel state information (CSI) frame.

In some examples, the channel sounding component 1545 is configurable or configured to transmit, during the first channel sounding procedure, a first null data packet frame concurrent with transmission of a second null data packet frame by the second AP.

In some examples, the first operating state is a listening state and the second operating state is an active state. In some examples, reception of the ICR from the one or more STAs indicates a transition from the listening state to the active state.

In some examples, the ICR component 1535 is configurable or configured to receive, from a first STA of the one or more STAs, a first ICR that indicates unavailability information associated with the first STA, where a first null data packet frame and a second null data packet frame are transmitted in accordance with the unavailability information.

In some examples, the first operating state is a low capability state and the second operating state is a high capability state. In some examples, reception of the ICR from the one or more STAs indicates transition from the low capability state to the high capability state.

In some examples, to support transmitting the ICF, the ICR component 1535 is configurable or configured to transmit a request for the one or more STAs to transmit the ICR in a trigger-based physical layer protocol. In some examples, to support transmitting the ICF, the CBF component 1525 is configurable or configured to transmit, to the second AP, a request for the second AP to transition from a first operating state to a second operating state.

Additionally, or alternatively, the wireless communication device 1500 may support wireless communications in accordance with examples as disclosed herein. In some examples, the ICF component 1530 is configurable or configured to transmit, to one or more STAs of a set of multiple STAs, an initial control frame (ICF) to trigger the one or more STAs to transition from a first operating state to a second operating state, where transmission of the ICF is associated with a set of multiple channel sounding procedures. In some examples, the ICR component 1535 is configurable or configured to monitor, during a first channel sounding procedure of the set of multiple channel sounding procedures, for an ICR from the one or more STAs based on the ICF, where exchange of the ICF and the ICR occurs between each channel sounding procedure of the set of multiple channel sounding procedures. In some examples, the channel sounding component 1545 is configurable or configured to transmit, to a set of first STAs associated with the first AP and based on the ICR, a first null data packet announcement frame during the first channel sounding procedure. In some examples, the channel sounding component 1545 is configurable or configured to transmit, to the set of first STAs, a first null data packet frame based on the first null data packet announcement frame. In some examples, the channel sounding component 1545 is configurable or configured to trigger the second AP to transmit a second null data packet frame during the first channel sounding procedure. In some examples, the channel sounding component 1545 is configurable or configured to transmit, to the set of first STAs associated with the first AP and based on the first null data packet frame, a beamforming report poll frame during the first channel sounding procedure. In some examples, the CSI component 1550 is configurable or configured to receive, based on the beamforming report poll frame, a channel state information frame from the set of first STAs associated with the first AP.

In some examples, the first null data packet frame is transmitted concurrent with transmission of a second null data packet frame by the second AP.

In some examples, the first operating state is a listening state and the second operating state is an active state. In some examples, reception of the ICR from the one or more STAs indicates a transition from the listening state to the active state.

In some examples, the ICR component 1535 is configurable or configured to receive, from a first STA of the one or more STAs, a first ICR that indicates unavailability information associated with the first STA, where a first null data packet frame and a second null data packet frame are transmitted in accordance with the unavailability information.

In some examples, the first operating state is a low capability state and the second operating state is a high capability state. In some examples, reception of the ICR from the one or more STAs indicates transition from the low capability state to the high capability state.

In some examples, to support transmitting the ICF, the ICR component 1535 is configurable or configured to transmit a request for the one or more STAs to transmit the ICR in a trigger-based physical layer protocol. In some examples, to support transmitting the ICF, the CBF component 1525 is configurable or configured to transmit, to the second AP, a request for the second AP to transition from a first operating state to a second operating state.

FIG. 16 shows a flowchart illustrating an example process 1600 performable by or at a first AP that supports operating state transitions in overlapping basic service sets. The operations of the process 1600 may be implemented by a first AP or its components as described herein. For example, the process 1600 may be performed by a wireless communication device, such as the wireless communication device 1500 described with reference to FIG. 15, operating as or within a wireless AP. In some examples, the process 1600 may be performed by a wireless AP, such as one of the APs 102 described with reference to FIG. 1.

In some examples, in 1605, the first AP may communicate, with a second AP, a coordinated beamforming trigger frame associated with triggering a set of multiple stations (STAs) to transition from a first operating state to a second operating state for reception of coordinated beamformed messaging by the first AP and the second AP. The operations of 1605 may be performed in accordance with examples as disclosed herein. In some implementations, aspects of the operations of 1605 may be performed by a CBF component 1525 as described with reference to FIG. 15.

In some examples, in 1610, the first AP may transmit, to one or more STAs of the set of multiple STAs, an initial control frame (ICF) to trigger the one or more STAs to transition from the first operating state to the second operating state. The operations of 1610 may be performed in accordance with examples as disclosed herein. In some implementations, aspects of the operations of 1610 may be performed by an ICF component 1530 as described with reference to FIG. 15.

In some examples, in 1615, the first AP may receive, from the one or more STAs, an initial control response (ICR) based on the ICF. The operations of 1615 may be performed in accordance with examples as disclosed herein. In some implementations, aspects of the operations of 1615 may be performed by an ICR component 1535 as described with reference to FIG. 15.

In some examples, in 1620, the first AP may transmit, to the one or more STAs, a data message based on the ICR and the coordinated beamforming trigger frame. The operations of 1620 may be performed in accordance with examples as disclosed herein. In some implementations, aspects of the operations of 1620 may be performed by a data component 1540 as described with reference to FIG. 15.

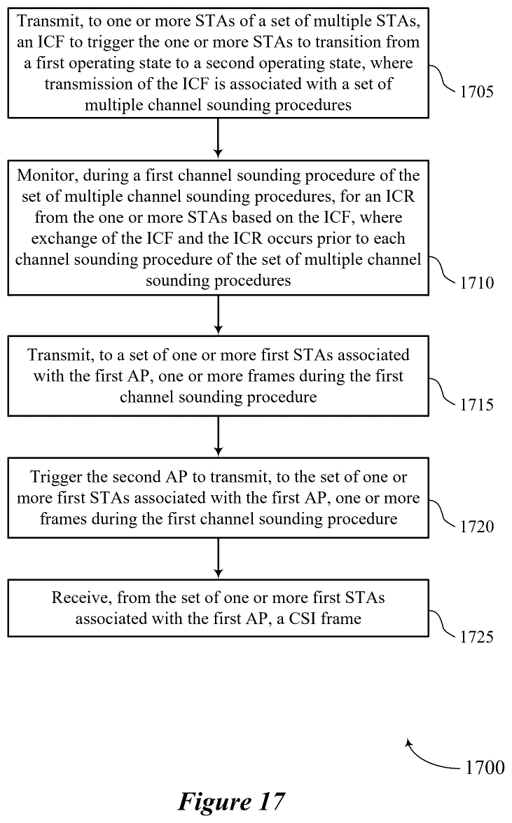

FIG. 17 shows a flowchart illustrating an example process 1700 performable by or at a first AP that supports operating state transitions in overlapping basic service sets. The operations of the process 1700 may be implemented by a first AP or its components as described herein. For example, the process 1700 may be performed by a wireless communication device, such as the wireless communication device 1500 described with reference to FIG. 15, operating as or within a wireless AP. In some examples, the process 1700 may be performed by a wireless AP, such as one of the APs 102 described with reference to FIG. 1.

In some examples, in 1705, the first AP may transmit, to one or more STAs of a set of multiple STAs, an initial control frame (ICF) to trigger the one or more STAs to transition from a first operating state to a second operating state, where transmission of the ICF is associated with a set of multiple channel sounding procedures. The operations of 1705 may be performed in accordance with examples as disclosed herein. In some implementations, aspects of the operations of 1705 may be performed by an ICF component 1530 as described with reference to FIG. 15.

In some examples, in 1710, the first AP may monitor, during a first channel sounding procedure of the set of multiple channel sounding procedures, for an ICR from the one or more STAs based on the ICF, where exchange of the ICF and the ICR occurs prior to each channel sounding procedure of the set of multiple channel sounding procedures. The operations of 1710 may be performed in accordance with examples as disclosed herein. In some implementations, aspects of the operations of 1710 may be performed by an ICR component 1535 as described with reference to FIG. 15.

In some examples, in 1715, the first AP may transmit, to a set of one or more first STAs associated with the first AP, one or more frames during the first channel sounding procedure. The operations of 1715 may be performed in accordance with examples as disclosed herein. In some implementations, aspects of the operations of 1715 may be performed by a channel sounding component 1545 as described with reference to FIG. 15.

In some examples, in 1720, the first AP may trigger the second AP to transmit, to the set of one or more first STAs associated with the first AP, one or more frames during the first channel sounding procedure. The operations of 1720 may be performed in accordance with examples as disclosed herein. In some implementations, aspects of the operations of 1720 may be performed by a channel sounding component 1545 as described with reference to FIG. 15.

In some examples, in 1725, the first AP may receive, from the set of one or more first STAs associated with the first AP, a CSI frame. The operations of 1725 may be performed in accordance with examples as disclosed herein. In some implementations, aspects of the operations of 1725 may be performed by a CSI component 1550 as described with reference to FIG. 15.

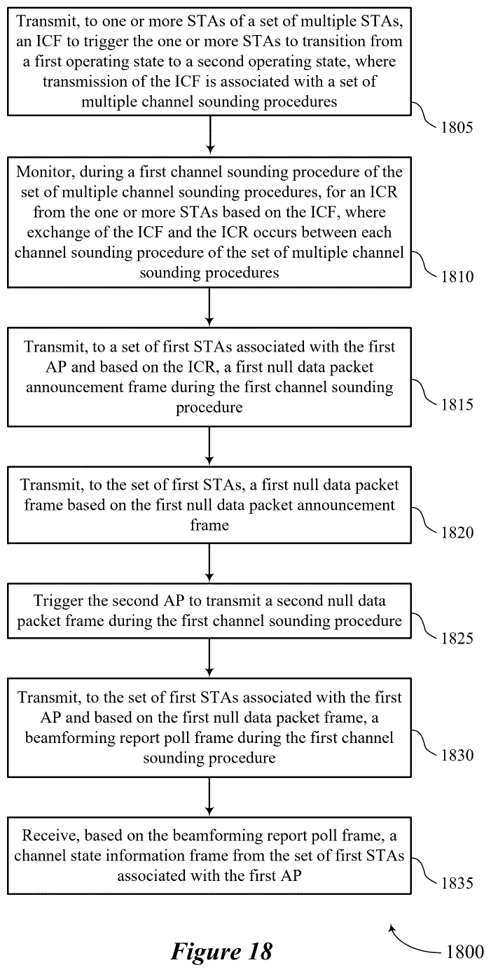

FIG. 18 shows a flowchart illustrating an example process 1800 performable by or at a first AP that supports operating state transitions in overlapping basic service sets. The operations of the process 1800 may be implemented by a first AP or its components as described herein. For example, the process 1800 may be performed by a wireless communication device, such as the wireless communication device 1500 described with reference to FIG. 15, operating as or within a wireless AP. In some examples, the process 1800 may be performed by a wireless AP, such as one of the APs 102 described with reference to FIG. 1.

In some examples, in 1805, the first AP may transmit, to one or more STAs of a set of multiple STAs, an initial control frame (ICF) to trigger the one or more STAs to transition from a first operating state to a second operating state. The operations of 1805 may be performed in accordance with examples as disclosed herein. In some implementations, aspects of the operations of 1805 may be performed by an ICF component 1530 as described with reference to FIG. 15.

In some examples, in 1810, the first AP may monitor, during a first channel sounding procedure of the set of multiple channel sounding procedures, for an ICR from the one or more STAs based on the ICF, wherein exchange of the ICF and the ICR occurs between each channel sounding procedure of the set of multiple channel sounding procedures. The operations of 1810 may be performed in accordance with examples as disclosed herein. In some implementations, aspects of the operations of 1810 may be performed by an ICR component 1535 as described with reference to FIG. 15.

In some examples, in 1815, the first AP may transmit, to a set of first STAs associated with the first AP and based on the ICR, a first null data packet announcement frame during the first channel sounding procedure. The operations of 1815 may be performed in accordance with examples as disclosed herein. In some implementations, aspects of the operations of 1815 may be performed by a channel sounding component 1545 as described with reference to FIG. 15.

In some examples, in 1820, the first AP may transmit, to the set of first STAs, a first null data packet frame based on the first null data packet announcement frame. The operations of 1820 may be performed in accordance with examples as disclosed herein. In some implementations, aspects of the operations of 1820 may be performed by a channel sounding component 1545 as described with reference to FIG. 15.

In some examples, in 1825, the first AP may trigger the second AP to transmit a second null data packet frame during the first channel sounding procedure. The operations of 1825 may be performed in accordance with examples as disclosed herein. In some implementations, aspects of the operations of 1825 may be performed by a channel sounding component 1545 as described with reference to FIG. 15.

In some examples, in 1830, the first AP may transmit, to the set of first STAs associated with the first AP and based on the first null data packet frame, a beamforming report poll frame during the first channel sounding procedure. The operations of 1830 may be performed in accordance with examples as disclosed herein. In some implementations, aspects of the operations of 1830 may be performed by a channel sounding component 1545 as described with reference to FIG. 15.

In some examples, in 1835, the first AP may receive, based on the beamforming report poll frame, a channel state information frame from the set of first STAs associated with the first AP. The operations of 1835 may be performed in accordance with examples as disclosed herein. In some implementations, aspects of the operations of 1835 may be performed by a CSI component 1550 as described with reference to FIG. 15.

The following provides an overview of aspects of the present disclosure:

Aspect 1: A method for wireless communications at a first AP, comprising: communicating, with a second AP, a coordinated beamforming trigger frame associated with triggering a plurality of stations (STAs) to transition from a first operating state to a second operating state for reception of coordinated beamformed messaging by the first AP and the second AP; transmitting, to one or more STAs of the plurality of STAs, an initial control frame (ICF) to trigger the one or more STAs to transition from the first operating state to the second operating state; receiving, from the one or more STAs, an initial control response (ICR) based at least in part on the ICF; and transmitting, to the one or more STAs, a data message based at least in part on the ICR and the coordinated beamforming trigger frame.

Aspect 2: The method of aspect 1, wherein communicating the coordinated beamforming trigger frame comprises: transmitting, to the second AP, the coordinated beamforming trigger frame, the method further comprising: receiving, from the second AP, a coordinated beamforming response frame based at least in part on the coordinated beamforming trigger frame.

Aspect 3: The method of any of aspects 1 through 2, wherein communicating the coordinated beamforming trigger frame comprises: receiving, from the second AP, the coordinated beamforming trigger frame, the method further comprising: transmitting, to the second AP, a coordinated beamforming response frame based at least in part on the coordinated beamforming trigger frame.

Aspect 4: The method of any of aspects 1 through 3, wherein the ICF is transmitted before a first time occasion associated with transmission of a second ICF by the second AP, and the first AP skips transmission during the first time occasion and during a second time occasion associated with transmission of a second ICR by a STA associated with the second AP.

Aspect 5: The method of any of aspects 1 through 4, further comprising: transmitting, to the one or more STAs of the plurality of STAs, an indication to switch from a default timeout period duration to an extended timeout period duration based at least in part on the ICF, wherein the indication indicates that the one or more STAs of the plurality of STAs are permitted to switch back to the first operating state after the extended timeout period duration if no frames are received during the extended timeout period duration.

Aspect 6: The method of any of aspects 1 through 5, wherein transmitting the ICF further comprises: transmitting the ICF concurrent with transmission of a second ICF by the second AP, wherein the ICF and the second ICF are identical and are transmitted synchronously, and wherein the ICR is received in a first set of resource units different from a second set of resource units used to transmit a second ICR by a STA associated with the second AP.

Aspect 7: The method of any of aspects 1 through 6, further comprising: transmitting, to the one or more STAs of the plurality of STAs, an earlier indication to respond to a frame comprising a unified transmitter address value, wherein the ICF is transmitted with the unified transmitter address value and wherein the ICR is received based at least in part on the indication and the unified transmitter address value.

Aspect 8: The method of any of aspects 1 through 7, wherein a basic service set color field is excluded from a physical header or set to.

Aspect 9: The method of any of aspects 1 through 8, wherein a basic service set color is indicated in a user information field within the ICF based at least in part on the first AP and the second AP sharing a same association identifier (AID).

Aspect 10: The method of any of aspects 1 through 9, wherein the processing system is further configured to cause the first AP to transmit, to the second AP, first STA information; and receive, from the second AP, second STA information, wherein the ICF is transmitted concurrently with transmission of a second ICF by the second AP based at least in part on the first STA information and the second STA information, wherein the ICF and the second ICF are identical and are transmitted synchronously.

Aspect 11: The method of any of aspects 1 through 10, wherein transmitting the ICF further comprises: transmitting, using a unified transmission address value, the ICF to a first subset of one or more STAs of the plurality of STAs, wherein the first subset of one or more STAs is associated with the first AP, and wherein the ICR is received in a first set of resource units different from a second set of resource units used to transmit a second ICR by a STA associated with the second AP; and transmitting, using the unified transmission address value, the ICF to a second subset of one or more STAs of the plurality of STAs, wherein the second subset of one or more STAs is associated with the second AP.

Aspect 12: The method of any of aspects 3 through 11, wherein the coordinated beamforming response frame and the ICF frame are transmitted in a same frame, and the ICR is received in a first set of resource units different from a second set of resource units used to transmit a second ICR by a STA associated with the second AP.

Aspect 13: The method of any of aspects 1 through 12, wherein transmitting the ICF further comprises: transmitting, via a first set of resource units, the ICF concurrent with transmission of a second ICF by the second AP via a second set of resource units; and receiving, via a third set of resource units, the ICR concurrent with transmission of a second ICR by a STA associated with the second AP via a fourth set of resource units.

Aspect 14: The method of any of aspects 1 through 13, further comprising: transmitting, to the second AP, an acknowledgment message, a synchronization message, or both, wherein the ICF and a second ICF are transmitted concurrently or staggered in time by the first AP and the second AP to the one or more STAs based at least in part on the acknowledgment message, the synchronization message, or both.

Aspect 15: The method of any of aspects 1 through 14, further comprising: transmitting, to the second AP, a synchronization message, wherein a first data message is transmitted to the one or more STAs concurrently with a second data message by the second AP based at least in part on the synchronization message.

Aspect 16: The method of any of aspects 1 through 15, further comprising: receiving, from the second AP, an acknowledgment message, a synchronization message, or both, wherein the ICF and a second ICF are transmitted concurrently or staggered in time by the first AP and the second AP to the one or more STAs based at least in part on the acknowledgment message, the synchronization message, or both.

Aspect 17: The method of any of aspects 1 through 16, further comprising: receiving, from the second AP, a synchronization message, wherein a second data message is transmitted to the one or more STAs concurrently with a first data message by the first AP based at least in part on the synchronization message.

Aspect 18: A method for wireless communications at a first AP, comprising: transmitting, to one or more STAs of a plurality of STAs, an initial control frame (ICF) to trigger the one or more STAs to transition from a first operating state to a second operating state, wherein transmission of the ICF is associated with a plurality of channel sounding procedures; monitoring, during a first channel sounding procedure of the plurality of channel sounding procedures, for an ICR from the one or more STAs based at least in part on the ICF, where exchange of the ICF and the ICR occurs prior to each channel sounding procedure of the set of multiple channel sounding procedures; transmitting, to a set of one or more first STAs associated with the first AP, one or more frames during the first channel sounding procedure; triggering the second AP to transmit, to the set of one or more first STAs associated with the first AP, one or more frames during the first channel sounding procedure; and receiving, from the set of one or more first STAs associated with the first AP, a CSI frame.

Aspect 19: The method of aspect 18, further comprising: transmitting, during the first channel sounding procedure, a first null data packet frame concurrent with transmission of a second null data packet frame by the second AP.

Aspect 20: The method of any of aspects 18 through 19, wherein the first operating state is a listening state and the second operating state is an active state, and reception of the ICR from the one or more STAs indicates a transition from the listening state to the active state.

Aspect 21: The method of any of aspects 18 through 20, further comprising: receiving, from a first STA of the one or more STAs, a first ICR that indicates unavailability information associated with the first STA, wherein a first null data packet frame and a second null data packet frame are transmitted in accordance with the unavailability information.

Aspect 22: The method of any of aspects 18 through 21, wherein the first operating state is a low capability state and the second operating state is a high capability state, and reception of the ICR from the one or more STAs indicates transition from the low capability state to the high capability state.

Aspect 23: The method of any of aspects 18 through 22, wherein transmitting the ICF further comprises: transmitting a request for the one or more STAs to transmit the ICR in a trigger-based physical layer protocol; and transmitting, to the second AP, a request for the second AP to transition from a first operating state to a second operating state.

Aspect 24: A method for wireless communications at a first AP, comprising: transmitting, to one or more STAs of a plurality of STAs, an initial control frame (ICF) to trigger the one or more STAs to transition from a first operating state to a second operating state, wherein transmission of the ICF is associated with a plurality of channel sounding procedures; monitoring, during a first channel sounding procedure of the plurality of channel sounding procedures, for an ICR from the one or more STAs based at least in part on the ICF, where exchange of the ICF and the ICR occurs between each channel sounding procedure of the set of multiple channel sounding procedures; transmitting, to a set of first STAs associated with the first AP and based at least in part on the ICR, a first null data packet announcement frame during the first channel sounding procedure; transmitting, to the set of first STAs, a first null data packet frame based at least in part on the first null data packet announcement frame; triggering the second AP to transmit a second null data packet frame during the first channel sounding procedure; transmitting, to the set of first STAs associated with the first AP and based at least in part on the first null data packet frame, a beamforming report poll frame during the first channel sounding procedure; and receiving, based at least in part on the beamforming report poll frame, a channel state information frame from the set of first STAs associated with the first AP.

Aspect 25: The method of aspect 24, wherein the first null data packet frame is transmitted concurrent with transmission of a second null data packet frame by the second AP.

Aspect 26: The method of any of aspects 24 through 25, wherein the first operating state is a listening state and the second operating state is an active state, and reception of the ICR from the one or more STAs indicates a transition from the listening state to the active state.

Aspect 27: The method of any of aspects 24 through 26, further comprising: receiving, from a first STA of the one or more STAs, a first ICR that indicates unavailability information associated with the first STA, wherein a first null data packet frame and a second null data packet frame are transmitted in accordance with the unavailability information.

Aspect 28: The method of any of aspects 24 through 27, wherein the first operating state is a low capability state and the second operating state is a high capability state, and reception of the ICR from the one or more STAs indicates transition from the low capability state to the high capability state.

Aspect 29: The method of any of aspects 24 through 28, wherein transmitting the ICF further comprises: transmitting a request for the one or more STAs to transmit the ICR in a trigger-based physical layer protocol; and transmitting, to the second AP, a request for the second AP to transition from a first operating state to a second operating state.

Aspect 30: A first AP for wireless communications, comprising one or more memories storing processor-executable code, and one or more processors coupled with the one or more memories and individually or collectively operable to execute the code to cause the first AP to perform a method of any of aspects 1 through 17.

Aspect 31: A first AP for wireless communications, comprising at least one means for performing a method of any of aspects 1 through 17.

Aspect 32: A non-transitory computer-readable medium storing code for wireless communications, the code comprising instructions executable by one or more processors to perform a method of any of aspects 1 through 17.

Aspect 33: A first AP for wireless communications, comprising one or more memories storing processor-executable code, and one or more processors coupled with the one or more memories and individually or collectively operable to execute the code to cause the first AP to perform a method of any of aspects 18 through 23.

Aspect 34: A first AP for wireless communications, comprising at least one means for performing a method of any of aspects 18 through 23.

Aspect 35: A non-transitory computer-readable medium storing code for wireless communications, the code comprising instructions executable by one or more processors to perform a method of any of aspects 18 through 23.

Aspect 36: A first AP for wireless communications, comprising one or more memories storing processor-executable code, and one or more processors coupled with the one or more memories and individually or collectively operable to execute the code to cause the first AP to perform a method of any of aspects 24 through 29.

Aspect 37: A first AP for wireless communications, comprising at least one means for performing a method of any of aspects 24 through 29.

Aspect 38: A non-transitory computer-readable medium storing code for wireless communications, the code comprising instructions executable by one or more processors to perform a method of any of aspects 24 through 29.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
communicate, with a second AP, a coordinated beamforming trigger frame associated with triggering a plurality of stations (STAs) to transition from a first operating state to a second operating state for reception of coordinated beamformed messaging by the first AP and the second AP;
transmit, to one or more STAs of the plurality of STAs, an initial control frame (ICF) to trigger the one or more STAs to transition from the first operating state to the second operating state;
receive, from the one or more STAs, an initial control response (ICR) based at least in part on the ICF; and
transmit, to the one or more STAs, a data message based at least in part on the ICR and the coordinated beamforming trigger frame.

2. The first AP of claim 1, wherein, to communicate the coordinated beamforming trigger frame, the processing system is configured to cause the first AP to:
transmit, to the second AP, the coordinated beamforming trigger frame, the processing system further configured to cause the first AP to:
receive, from the second AP, a coordinated beamforming response frame based at least in part on the coordinated beamforming trigger frame.

3. The first AP of claim 1, wherein, to communicate the coordinated beamforming trigger frame, the processing system is configured to cause the first AP to:
receive, from the second AP, the coordinated beamforming trigger frame, the processing system further configured to cause the first AP to:
transmit, to the second AP, a coordinated beamforming response frame based at least in part on the coordinated beamforming trigger frame.

4. The first AP of claim 1, wherein:
the ICF is transmitted before a first time occasion associated with transmission of a second ICF by the second AP, and
the first AP skips transmission during the first time occasion and during a second time occasion associated with transmission of a second ICR by a STA associated with the second AP.

5. The first AP of claim 1, wherein the processing system is further configured to cause the first AP to:
transmit, to the one or more STAs of the plurality of STAs, an indication to switch from a default timeout period duration to an extended timeout period duration based at least in part on the ICF, wherein the indication indicates that the one or more STAs of the plurality of STAs are permitted to switch back to the first operating state after the extended timeout period duration if no frames are received during the extended timeout period duration.

6. The first AP of claim 1, wherein, to transmit the ICF, the processing system is further configured to cause the first AP to:
transmit the ICF concurrent with transmission of a second ICF by the second AP, wherein the ICF and the second ICF are identical and are transmitted synchronously, and wherein the ICR is received in a first set of resource units different from a second set of resource units used to transmit a second ICR by a STA associated with the second AP.

7. The first AP of claim 1, wherein the processing system is further configured to cause the first AP to:
transmit, to the one or more STAs of the plurality of STAs, an earlier indication to respond to a frame comprising a unified transmitter address value, wherein the ICF is transmitted with the unified transmitter address value and wherein the ICR is received based at least in part on the indication and the unified transmitter address value.

8. The first AP of claim 1, wherein a basic service set color field is excluded from a physical header or set to 0.

9. The first AP of claim 1, wherein a basic service set color is indicated in a user information field within the ICF based at least in part on the first AP and the second AP sharing a same association identifier (AID).

10. The first AP of claim 1, wherein the processing system is further configured to cause the first AP to:
transmit, to the second AP, first STA information; and
receive, from the second AP, second STA information, wherein the ICF is transmitted concurrently with transmission of a second ICF by the second AP based at least in part on the first STA information and the second STA information, wherein the ICF and the second ICF are identical and are transmitted synchronously.

11. The first AP of claim 1, wherein, to transmit the ICF, the processing system is further configured to cause the first AP to:
transmit, using a unified transmission address value, the ICF to a first subset of one or more STAs of the plurality of STAs, wherein the first subset of one or more STAs is associated with the first AP, and wherein the ICR is received in a first set of resource units different from a second set of resource units used to transmit a second ICR by a STA associated with the second AP; and
transmit, using the unified transmission address value, the ICF to a second subset of one or more STAs of the plurality of STAs, wherein the second subset of one or more STAs is associated with the second AP.

12. The first AP of claim 3, wherein:
the coordinated beamforming response frame and the ICF are transmitted in a same frame, and
the ICR is received in a first set of resource units different from a second set of resource units used to transmit a second ICR by a STA associated with the second AP.

13. The first AP of claim 1, wherein, to transmit the ICF, the processing system is further configured to cause the first AP to:
transmit, via a first set of resource units, the ICF concurrent with transmission of a second ICF by the second AP via a second set of resource units; and
receive, via a third set of resource units, the ICR concurrent with transmission of a second ICR by a STA associated with the second AP via a fourth set of resource units.

14. The first AP of claim 1, wherein the processing system is further configured to cause the first AP to:
transmit, to the second AP, an acknowledgment message, a synchronization message, or both, wherein the ICF and a second ICF are transmitted concurrently or staggered in time by the first AP and the second AP to the one or more STAs based at least in part on the acknowledgment message, the synchronization message, or both.

15. The first AP of claim 1, wherein the processing system is further configured to cause the first AP to:
transmit, to the second AP, a synchronization message, wherein a first data message is transmitted to the one or more STAs concurrently with a second data message by the second AP based at least in part on the synchronization message.

16. The first AP of claim 1, wherein the processing system is further configured to cause the first AP to:
receive, from the second AP, an acknowledgment message, a synchronization message, or both, wherein the ICF and a second ICF are transmitted concurrently or staggered in time by the first AP and the second AP to the one or more STAs based at least in part on the acknowledgment message, the synchronization message, or both.

17. The first AP of claim 1, wherein the processing system is further configured to cause the first AP to:
receive, from the second AP, a synchronization message, wherein a second data message is transmitted to the one or more STAs concurrently with a first data message by the first AP based at least in part on the synchronization message.

18. A first access point (AP), comprising:
a processing system that includes processor circuitry and memory circuitry that stores code, the processing system configured to cause the first AP to:
transmit, to one or more STAs of a plurality of STAs, an initial control frame (ICF) to trigger the one or more STAs to transition from a first operating state to a second operating state, wherein transmission of the ICF is associated with a plurality of channel sounding procedures;
monitor, during a first channel sounding procedure of the plurality of channel sounding procedures, for an initial control response (ICR) from the one or more STAs based at least in part on the ICF, wherein exchange of the ICF and the ICR occurs prior to each channel sounding procedure of the plurality of channel sounding procedures;
transmit, to a set of one or more first STAs associated with the first AP, one or more frames during the first channel sounding procedure;
trigger a second AP to transmit, to the set of one or more first STAs associated with the first AP, one or more frames during the first channel sounding procedure; and
receive, from the set of one or more first STAs associated with the first AP, a channel state information (CSI) frame.

19. The first AP of claim 18, wherein the processing system is further configured to cause the first AP to:
transmit, during the first channel sounding procedure, a first null data packet frame concurrent with transmission of a second null data packet frame by the second AP.

20. The first AP of claim 18, wherein:
the first operating state is a listening state and the second operating state is an active state, and
reception of the ICR from the one or more STAs indicates a transition from the listening state to the active state.

21. The first AP of claim 18, wherein the processing system is further configured to cause the first AP to:
receive, from a first STA of the one or more STAs, a first ICR that indicates unavailability information associated with the first STA, wherein a first null data packet frame and a second null data packet frame are transmitted in accordance with the unavailability information.

22. The first AP of claim 18, wherein:
the first operating state is a low capability state and the second operating state is a high capability state, and
reception of the ICR from the one or more STAs indicates transition from the low capability state to the high capability state.

23. The first AP of claim 18, wherein, to transmit the ICF, the processing system is further configured to cause the first AP to:
transmit a request for the one or more STAs to transmit the ICR in a trigger-based physical layer protocol; and
transmit, to the second AP, a request for the second AP to transition from a first operating state to a second operating state.

24. A first access point (AP), comprising:
a processing system that includes processor circuitry and memory circuitry that stores code, the processing system configured to cause the first AP to:
transmit, to one or more STAs of a plurality of STAs, an initial control frame (ICF) to trigger the one or more STAs to transition from a first operating state to a second operating state, wherein transmission of the ICF is associated with a plurality of channel sounding procedures;
monitor, during a first channel sounding procedure of the plurality of channel sounding procedures, for an initial control response (ICR) from the one or more STAs based at least in part on the ICF, wherein exchange of the ICF and the ICR occurs between each channel sounding procedure of the plurality of channel sounding procedures;
transmit, to a set of first STAs associated with the first AP and based at least in part on the ICR, a first null data packet announcement frame during the first channel sounding procedure;
transmit, to the set of first STAs, a first null data packet frame based at least in part on the first null data packet announcement frame;
trigger a second AP to transmit a second null data packet frame during the first channel sounding procedure;
transmit, to the set of first STAs associated with the first AP and based at least in part on the first null data packet frame, a beamforming report poll frame during the first channel sounding procedure; and
receive, based at least in part on the beamforming report poll frame, a channel state information frame from the set of first STAs associated with the first AP.

25. The first AP of claim 24, wherein:
the first operating state is a listening state and the second operating state is an active state, and
reception of the ICR from the one or more STAs indicates a transition from the listening state to the active state.

26. The first AP of claim 24, wherein the processing system is further configured to cause the first AP to:
receive, from a first STA of the one or more STAs, a first ICR that indicates unavailability information associated with the first STA, wherein a first null data packet frame and a second null data packet frame are transmitted in accordance with the unavailability information.

27. The first AP of claim 24, wherein:
the first operating state is a low capability state and the second operating state is a high capability state, and
reception of the ICR from the one or more STAs indicates transition from the low capability state to the high capability state.

28. The first AP of claim 24, wherein, to transmit the ICF, the processing system is further configured to cause the first AP to:
transmit a request for the one or more STAs to transmit the ICR in a trigger-based physical layer protocol; and
transmit, to the second AP, a request for the second AP to transition from a first operating state to a second operating state.

29. A method for wireless communications at a first access point (AP), comprising:
transmitting, to one or more STAs of a plurality of STAs, an initial control frame (ICF) to trigger the one or more STAs to transition from a first operating state to a second operating state, wherein transmission of the ICF is associated with a plurality of channel sounding procedures;
monitoring, during a first channel sounding procedure of the plurality of channel sounding procedures, for an initial control response (ICR) from the one or more STAs based at least in part on the ICF, wherein exchange of the ICF and the ICR occurs prior to each channel sounding procedure of the plurality of channel sounding procedures;
transmitting, to a set of one or more first STAs associated with the first AP, one or more frames during the first channel sounding procedure;
triggering a second AP to transmit, to the set of one or more first STAs associated with the first AP, one or more frames during the first channel sounding procedure; and
receiving, from the set of one or more first STAs associated with the first AP, a channel state information (CSI) frame.

30. The method of claim 29, further comprising:
transmitting, during the first channel sounding procedure, a first null data packet frame concurrent with transmission of a second null data packet frame by the second AP.
